(19) United States
(12) Patent Application Publication
(10) Pub. No.: US 2024/0340071 A1
(43) Pub. Date: Oct. 10, 2024

(54) COMMUNICATION METHOD AND COMMUNICATION APPARATUS

(71) Applicant: HUAWEI TECHNOLOGIES CO., LTD., Shenzhen (CN)

(72) Inventors: Yue ZHOU, Shenzhen (CN); Ying CHEN, Hangzhou (CN); Jun WANG, Hangzhou (CN)

(73) Assignee: HUAWEI TECHNOLOGIES CO., LTD., Shenzhen (CN)

(21) Appl. No.: 18/746,564

(22) Filed: Jun. 18, 2024

Related U.S. Application Data
(63) Continuation of application No. PCT/CN2022/133857, filed on Nov. 24, 2022.

(30) Foreign Application Priority Data
Dec. 22, 2021 (CN) 202111578000.6

(51) Int. Cl. H04B 7/10; H04L 5/00; H04W 28/02

(52) U.S. Cl. CPC H04B 7/10; H04L 5/0048; H04W 28/0215

(57) ABSTRACT

A communication method and a communication apparatus. The method includes: a terminal device receives first indication information from a network device, where the first indication information indicates the terminal device to feed back a first parameter, the first parameter indicates a degree of crosstalk between a first reference signal and a second reference signal, the first reference signal and the second reference signal are transmitted on a first time domain resource, a first frequency domain resource, and a first space domain resource, the first reference signal is transmitted in a first polarization direction, the second reference signal is transmitted in a second polarization direction, and the first polarization direction and the second polarization direction are two mutually orthogonal polarization directions used for a polarization multiplexing mechanism.

### CROSS-REFERENCE TO RELATED APPLICATIONS

This application is a continuation of International Application No. PCT/CN2022/133857, filed on Nov. 24, 2022, which claims priority to Chinese Patent Application No. 202111578000.6, filed on Dec. 22, 2021. The disclosures of the aforementioned applications are hereby incorporated by reference in their entireties.

### TECHNICAL FIELD

Embodiments relate to the communication field, and to a communication method and a communication apparatus.

### BACKGROUND

An electric field vector of electromagnetic wave radiation may change in a rotating or linear manner, and two corresponding electromagnetic waves are respectively referred to as a circularly polarized wave and a linearly polarized wave. A polarized wave attenuates slower within a same distance. Therefore, in an NTN (Non-Terrestrial Network) system, the circularly polarized wave and the linearly polarized wave are mostly used for communication.

Circularly polarized waves include a left-hand circularly polarized wave and a right-hand circularly polarized wave whose transmission directions are mutually orthogonal. As shown in FIG. 1, in an ideal status, circularly polarized waves that are mutually orthogonal in same frequency domain do not affect each other during transmission in same time domain and same space domain. Linearly polarized waves include a vertically linearly polarized wave and a horizontally linearly polarized wave whose transmission directions are mutually orthogonal. In addition, there are positive 45-degree and negative 45-degree polarized waves that are mutually orthogonal. Polarization multiplexing means that electromagnetic waves are transmitted in same time domain and same space domain by simultaneously using mutually orthogonal polarization manners in a same frequency band. A coverage capability, stability, and a throughput of a system link can be improved by using a polarization multiplexing mechanism.

However, in an actual dual polarization frequency reuse system (DPFR) or polarization wavelength division multiplexing (PWDM) system, isolation characteristics of signals on orthogonally polarized channels are affected by a non-ideal characteristic of actual hardware and a common atmospheric phenomenon. Consequently, signal crosstalk occurs in different polarization directions. When a degree of crosstalk is greater than a specific limit, a base station and a terminal device cannot operate normally, and the polarization multiplexing mechanism does not make sense.

### SUMMARY

Embodiments provide a communication method and a communication apparatus. A network device indicates a terminal device to measure a degree of crosstalk between reference signals transmitted in mutually orthogonal polarization directions on a same frequency domain resource, a same time domain resource, and a same space domain resource, or a network device indicates a terminal device to send, to the network device, reference signals transmitted in mutually orthogonal polarization directions on a same frequency domain resource, a same time domain resource, and a same space domain resource. The network device measures a degree of crosstalk between the reference signals. When the degree of crosstalk can meet a link requirement, the network device indicates the terminal device to receive downlink information or send uplink information in a polarization multiplexing manner. This can ensure stability of an entire link after polarization multiplexing is enabled. In addition, data is transmitted in the polarization multiplexing manner, so that a link throughput can be improved, system communication efficiency can be improved, and spectrum resources can be reduced.

According to a first aspect, a communication method is provided. The method includes: a terminal device receives first indication information from a network device, where the first indication information indicates the terminal device to feed back a first parameter, the first parameter indicates a degree of crosstalk between a first reference signal and a second reference signal, the first reference signal and the second reference signal are transmitted on a first time domain resource, a first frequency domain resource, and a first space domain resource, the first reference signal is transmitted in a first polarization direction, the second reference signal is transmitted in a second polarization direction, and the first polarization direction and the second polarization direction are two mutually orthogonal polarization directions used for a polarization multiplexing mechanism. The terminal device measures the first reference signal and the second reference signal based on the first indication information, to obtain the first parameter. The terminal device sends the first parameter to the network device.

Optionally, the first polarization direction may be left-hand circular polarization, and the second polarization direction may be right-hand circular polarization.

Optionally, the first polarization direction may be horizontal linear polarization, and the second polarization direction may be vertical linear polarization.

Optionally, the first polarization direction may be positive 45-degree polarization, and the second polarization direction may be negative 45-degree polarization.

According to the communication method provided in this embodiment, the network device indicates the terminal device to measure a degree of crosstalk between reference signals transmitted in mutually orthogonal polarization directions on a same frequency domain resource, a same time domain resource, and a same space domain resource. When the degree of crosstalk can meet a link requirement, the network device indicates the terminal device to receive downlink information in a polarization multiplexing manner. This can ensure stability of an entire link after polarization multiplexing is enabled. In addition, data is transmitted in the polarization multiplexing manner, so that a link throughput can be improved, system communication efficiency can be improved, and spectrum resources can be reduced.

With reference to the first aspect, in some implementations of the first aspect, before the terminal device receives the first indication information from the network device, the method further includes: the terminal device reports a capability to the network device, that is, the terminal device sends first capability indication information to the network device, where the first capability indication information indicates that the terminal device supports the polarization multiplexing mechanism.

It should be understood that, that the terminal device supports the polarization multiplexing mechanism may be that the terminal device has a receive antenna for receiving reference signals transmitted in the first polarization direction and the second polarization direction.

With reference to the first aspect, in some implementations of the first aspect, that the terminal device measures the first reference signal and the second reference signal based on the first indication information may be one or more of the following:

The terminal device measures first signal energy and second signal energy;
the terminal device measures third signal energy and fourth signal energy;
the terminal device measures the first signal energy and the fourth signal energy; or
the terminal device measures the second signal energy and the third signal energy.

The first signal energy is energy of the first reference signal in the first polarization direction, the second signal energy is energy of the second reference signal in the first polarization direction, the third signal energy is energy of the second reference signal in the second polarization direction, and the fourth signal energy is energy of the first reference signal in the second polarization direction.

An item or items that is/are to be measured by the terminal device is/are determined by the terminal device based on actual measurement data, or determined by the terminal device based on preconfiguration information of the network device, or determined by the terminal device based on indication information of the network device.

With reference to the first aspect, in some implementations of the first aspect, the first parameter includes one or more of the following:
the first signal energy and the second signal energy;
the third signal energy and the fourth signal energy;
the first signal energy and the fourth signal energy;
the second signal energy and the third signal energy;
first cross-polarization discrimination (XPD1) corresponding to the first reference signal, where
the XPD1 is determined based on a ratio of the first signal energy to the fourth signal energy;
second cross-polarization discrimination (XPD2) corresponding to the second reference signal, where
the XPD2 is determined based on a ratio of the third signal energy to the second signal energy;
first cross-polarization isolation (I1) corresponding to the first reference signal, where
the I1 is determined based on a ratio of the first signal energy to the second signal energy;
second cross-polarization isolation (I2) corresponding to the second reference signal, where
the I2 is determined based on a ratio of the third signal energy to the fourth signal energy;
a result of comparison between the XPD1 and a first preset value;
a result of comparison between the XPD2 and the first preset value;
a result of comparison between the I1 and a second preset value; or
a result of comparison between the I2 and the second preset value.

It should be noted that smaller values of cross-polarization isolation and cross-polarization discrimination indicate a more serious degree of crosstalk.

With reference to the first aspect, in some implementations of the first aspect, the first reference signal and the second reference signal are generated based on a pseudo-random sequence signal pair, and sequence initialization values corresponding to the first reference signal and the second reference signal are different from sequence initialization values corresponding to the pseudo-random sequence signal pair.

With reference to the first aspect, in some implementations of the first aspect, the terminal device receives second indication information sent by the network device, where the second indication information is determined based on the first parameter, and the second indication information indicates whether the terminal device receives downlink information by using the polarization multiplexing mechanism. The terminal device determines, based on the second indication information, whether to receive the downlink information by using the polarization multiplexing mechanism.

With reference to the first aspect, in some implementations of the first aspect, the first indication information and/or the second indication information are/is transmitted in the first polarization direction, or the first indication information and/or the second indication information are/is transmitted in the second polarization direction.

According to a second aspect, a communication method is provided. The method includes: a terminal device receives third indication information from a network device, where the third indication information indicates the terminal device to send a third reference signal and a fourth reference signal to the network device on a second time domain resource, a second frequency domain resource, and a second space domain resource, the third reference signal and the fourth reference signal are used by the network device to determine a second parameter, the second parameter indicates a degree of crosstalk between the third reference signal and the fourth reference signal, the third reference signal is transmitted in a third polarization direction, the fourth reference signal is transmitted in a fourth polarization direction, and the third polarization direction and the fourth polarization direction are two mutually orthogonal polarization directions used for a polarization multiplexing mechanism. The terminal device sends the third reference signal and the fourth reference signal to the network device based on the third indication information.

Optionally, the third polarization direction may be left-hand circular polarization, and the fourth polarization direction may be right-hand circular polarization.

Optionally, the third polarization direction may be horizontal linear polarization, and the fourth polarization direction may be vertical linear polarization.

Optionally, the third polarization direction may be positive 45-degree polarization, and the fourth polarization direction may be negative 45-degree polarization.

According to the communication method provided in this embodiment, the network device indicates the terminal device to send, to the network device on a same frequency domain resource, a same time domain resource, and a same space domain resource, reference signals transmitted in mutually orthogonal polarization directions. The network device measures a degree of crosstalk between the mutually orthogonal signals. When the degree of crosstalk can meet a link requirement, the network device indicates the terminal device to send uplink information in a polarization multiplexing manner. This can ensure stability of an entire link after polarization multiplexing is enabled. In addition, data is transmitted in the polarization multiplexing manner, so that a link throughput can be improved, system communication efficiency can be improved, and spectrum resources can be reduced.

With reference to the second aspect, in some implementations of the second aspect, before the terminal device receives the third indication information from the network device, the method further includes: the terminal device reports a capability to the network device. The terminal device sends second capability indication information to the network device, where the second capability indication information indicates that the terminal device supports the polarization multiplexing mechanism.

It should be understood that, that the terminal device supports the polarization multiplexing mechanism may be that the terminal device has a transmit antenna for sending reference signals transmitted in the third polarization direction and the fourth polarization direction.

With reference to the second aspect, in some implementations of the second aspect, the second parameter includes one or more of the following:
fifth signal energy and sixth signal energy;
seventh signal energy and eighth signal energy;
the fifth signal energy and the eighth signal energy;
the sixth signal energy and the seventh signal energy, where
the fifth signal energy is energy of the third reference signal in the third polarization direction, the sixth signal energy is energy of the fourth reference signal in the third polarization direction, the seventh signal energy is energy of the fourth reference signal in the fourth polarization direction, and the eighth signal energy is energy of the third reference signal in the fourth polarization direction;
third cross-polarization discrimination (XPD3) corresponding to the third reference signal, where
the XPD3 is determined based on a ratio of the fifth signal energy to the eighth signal energy;
fourth cross-polarization discrimination (XPD4) corresponding to the fourth reference signal, where
the XPD4 is determined based on a ratio of the seventh signal energy to the sixth signal energy;
third cross-polarization isolation (I3) corresponding to the third reference signal, where the I3 is determined based on a ratio of the fifth signal energy to the sixth signal energy;
fourth cross-polarization isolation (I4) corresponding to the fourth reference signal, where
the I4 is determined based on a ratio of the seventh signal energy to the eighth signal energy;
a result of comparison between the XPD3 and a third preset value;
a result of comparison between the XPD4 and the third preset value;
a result of comparison between the I3 and a fourth preset value; or
a result of comparison between the I4 and the fourth preset value.

With reference to the second aspect, in some implementations of the second aspect, the third reference signal and the fourth reference signal are generated based on a pseudo-random sequence signal pair, and sequence initialization values corresponding to the third reference signal and the fourth reference signal are different from sequence initialization values corresponding to the pseudo-random sequence signal pair.

With reference to the second aspect, in some implementations of the second aspect, the terminal device receives fourth indication information sent by the network device, where the fourth indication information is determined by the network device based on the second parameter, and the fourth indication information indicates whether the terminal device sends uplink information by using the polarization multiplexing mechanism. The terminal device determines, based on the fourth indication information, whether to send the uplink information by using the polarization multiplexing mechanism.

With reference to the second aspect, in some implementations of the second aspect, the third indication information and/or the fourth indication information are/is transmitted in the third polarization direction, or the third indication information and/or the fourth indication information are/is transmitted in the fourth polarization direction.

According to a third aspect, a communication method is provided. The method includes: a network device sends first indication information to a terminal device, where the first indication information indicates the terminal device to feed back a first parameter, the first parameter indicates a degree of crosstalk between a first reference signal and a second reference signal, the first reference signal and the second reference signal are transmitted on a first time domain resource, a first frequency domain resource, and a first space domain resource, the first reference signal is transmitted in a first polarization direction, the second reference signal is transmitted in a second polarization direction, and the first polarization direction and the second polarization direction are two mutually orthogonal polarization directions used for a polarization multiplexing mechanism. The network device sends the first reference signal and the second reference signal to the terminal device. The network device receives the first parameter sent by the terminal device.

Optionally, the first polarization direction may be left-hand circular polarization, and the second polarization direction may be right-hand circular polarization.

Optionally, the first polarization direction may be horizontal linear polarization, and the second polarization direction may be vertical linear polarization.

Optionally, the first polarization direction may be positive 45-degree polarization, and the second polarization direction may be negative 45-degree polarization.

According to the communication method provided in this embodiment, the network device indicates the terminal device to measure a degree of crosstalk between reference signals transmitted in mutually orthogonal polarization directions on a same frequency domain resource, a same time domain resource, and a same space domain resource. When the degree of crosstalk can meet a link requirement, the network device indicates the terminal device to receive downlink information in a polarization multiplexing manner. This can ensure stability of an entire link after polarization multiplexing is enabled. In addition, data is transmitted in the polarization multiplexing manner, so that a link throughput can be improved, system communication efficiency can be improved, and spectrum resources can be reduced.

With reference to the third aspect, in some implementations of the third aspect, before the network device sends the first indication information to the terminal device, the method further includes: the network device receives a capability reported by the terminal device, that is, the network device receives first capability indication information from the terminal device, where the first capability indication information indicates that the terminal device supports the polarization multiplexing mechanism.

It should be understood that, that the terminal device supports the polarization multiplexing mechanism may be that the terminal device has a receive antenna for receiving reference signals transmitted in the first polarization direction and the second polarization direction.

With reference to the third aspect, in some implementations of the third aspect, the first parameter includes one or more of the following:
first signal energy and second signal energy, where the first signal energy is energy of the first reference signal in the first polarization direction, and the second signal energy is energy of the second reference signal in the first polarization direction;
third signal energy and fourth signal energy, where the third signal energy is energy of the second reference signal in the second polarization direction, and the fourth signal energy is energy of the first reference signal in the second polarization direction;
the first signal energy and the fourth signal energy;
the second signal energy and the third signal energy;
first cross-polarization discrimination (XPD1) corresponding to the first reference signal, where
the XPD1 is determined based on a ratio of the first signal energy to the fourth signal energy;
second cross-polarization discrimination (XPD2) corresponding to the second reference signal, where
the XPD2 is determined based on a ratio of the third signal energy to the second signal energy;
first cross-polarization isolation (I1) corresponding to the first reference signal, where
the I1 is determined based on a ratio of the first signal energy to the second signal energy;
second cross-polarization isolation (I2) corresponding to the second reference signal, where
the I2 is determined based on a ratio of the third signal energy to the fourth signal energy;
a result of comparison between the XPD1 and a first preset value;
a result of comparison between the XPD2 and the first preset value;
a result of comparison between the I1 and a second preset value; or
a result of comparison between the I2 and the second preset value.

With reference to the third aspect, in some implementations of the third aspect, the first reference signal and the second reference signal are generated based on a pseudo-random sequence signal pair, and sequence initialization values corresponding to the first reference signal and the second reference signal are different from sequence initialization values corresponding to the pseudo-random sequence signal pair.

With reference to the third aspect, in some implementations of the third aspect, the network device sends second indication information to the terminal device, where the second indication information is determined based on the first parameter, and the second indication information indicates whether the terminal device receives downlink information by using the polarization multiplexing mechanism.

With reference to the third aspect, in some implementations of the third aspect, the first indication information and/or the second indication information are/is transmitted in the first polarization direction, or the first indication information and/or the second indication information are/is transmitted in the second polarization direction.

According to a fourth aspect, a communication method is provided. The method includes: a network device sends third indication information to a terminal device, where the third indication information indicates the terminal device to send a third reference signal and a fourth reference signal to the network device on a second time domain resource, a second frequency domain resource, and a second space domain resource, the third reference signal and the fourth reference signal are used by the network device to determine a second parameter, the second parameter indicates a degree of crosstalk between the third reference signal and the fourth reference signal, the third reference signal is transmitted in a third polarization direction, the fourth reference signal is transmitted in a fourth polarization direction, and the third polarization direction and the fourth polarization direction are mutually orthogonal polarization directions used for a polarization multiplexing mechanism. The network device measures the third reference signal and the fourth reference signal, to determine the second parameter.

Optionally, the third polarization direction may be left-hand circular polarization, and the fourth polarization direction may be right-hand circular polarization.

Optionally, the third polarization direction may be horizontal linear polarization, and the fourth polarization direction may be vertical linear polarization.

Optionally, the third polarization direction may be positive 45-degree polarization, and the fourth polarization direction may be negative 45-degree polarization.

According to the communication method provided in this embodiment, the network device indicates the terminal device to send, to the network device on a same frequency domain resource, a same time domain resource, and a same space domain resource, reference signals transmitted in mutually orthogonal polarization directions. The network device measures a degree of crosstalk between the mutually orthogonal signals. When the degree of crosstalk can meet a link requirement, the network device indicates the terminal device to send uplink information in a polarization multiplexing manner. This can ensure stability of an entire link after polarization multiplexing is enabled. In addition, data is transmitted in the polarization multiplexing manner, so that a link throughput can be improved, system communication efficiency can be improved, and spectrum resources can be reduced.

With reference to the fourth aspect, in some implementations of the fourth aspect, before the network device sends the third indication information to the terminal device, the method further includes: the network device receives a capability reported by the terminal device, that is, the network device receives second capability indication information sent by the terminal device, where the second capability indication information indicates that the terminal device supports the polarization multiplexing mechanism.

It should be understood that, that the terminal device supports the polarization multiplexing mechanism may be that the terminal device has a transmit antenna for sending reference signals transmitted in the third polarization direction and the fourth polarization direction.

With reference to the fourth aspect, in some implementations of the fourth aspect, that the network device measures the third reference signal and the fourth reference signal includes one or more of the following:

The network device measures fifth signal energy and sixth signal energy;
the network device measures seventh signal energy and eighth signal energy;
the network device measures the fifth signal energy and the eighth signal energy; or
the network device measures the sixth signal energy and the seventh signal energy.

The fifth signal energy is energy of the third reference signal in the third polarization direction, the sixth signal energy is energy of the fourth reference signal in the third polarization direction, the seventh signal energy is energy of the fourth reference signal in the fourth polarization direction, and the eighth signal energy is energy of the third reference signal in the fourth polarization direction.

With reference to the fourth aspect, in some implementations of the fourth aspect, the second parameter includes one or more of the following:
the fifth signal energy and the sixth signal energy;
the seventh signal energy and the eighth signal energy;
the fifth signal energy and the eighth signal energy;
the sixth signal energy and the seventh signal energy;
third cross-polarization discrimination (XPD3) corresponding to the third reference signal, where
the XPD3 is determined based on a ratio of the fifth signal energy to the eighth signal energy;
fourth cross-polarization discrimination (XPD4) corresponding to the fourth reference signal, where
the XPD4 is determined based on a ratio of the seventh signal energy to the sixth signal energy;
third cross-polarization isolation (I3) corresponding to the third reference signal, where the I3 is determined based on a ratio of the fifth signal energy to the sixth signal energy;
fourth cross-polarization isolation (I4) corresponding to the fourth reference signal, where
the I4 is determined based on a ratio of the seventh signal energy to the eighth signal energy;
a result of comparison between the XPD3 and a third preset value;
a result of comparison between the XPD4 and the third preset value;
a result of comparison between the I3 and a fourth preset value; or
a result of comparison between the I4 and the fourth preset value.

With reference to the fourth aspect, in some implementations of the fourth aspect, the third reference signal and the fourth reference signal are generated based on a pseudo-random sequence signal pair, and sequence initialization values corresponding to the third reference signal and the fourth reference signal are different from sequence initialization values corresponding to the pseudo-random sequence signal pair.

With reference to the fourth aspect, in some implementations of the fourth aspect, the network device sends fourth indication information to the terminal device, where the fourth indication information is determined by the network device based on the second parameter, and the fourth indication information indicates whether the terminal device sends uplink information by using the polarization multiplexing mechanism.

With reference to the fourth aspect, in some implementations of the fourth aspect, the third indication information and/or the fourth indication information are/is transmitted in the third polarization direction, or the third indication information and/or the fourth indication information are/is transmitted in the fourth polarization direction.

According to a fifth aspect, a communication apparatus is provided. The communication apparatus includes units configured to perform the steps of the communication method in the first aspect or the second aspect and the implementations of the first aspect or the second aspect.

In an implementation, the communication apparatus is a communication chip. The communication chip may include an input circuit or an interface configured to send information or data, and an output circuit or an interface configured to receive information or data.

In another implementation, the communication apparatus is a communication device (for example, a terminal device). The communication chip may include a transmitter configured to send information, and a receiver configured to receive information or data.

According to a sixth aspect, a communication apparatus is provided. The communication apparatus includes units configured to perform the steps of the communication method in the third aspect or the fourth aspect and the implementations of the third aspect or the fourth aspect.

In an implementation, the communication apparatus is a communication chip. The communication chip may include an input circuit or an interface configured to send information or data, and an output circuit or an interface configured to receive information or data.

In another implementation, the communication apparatus is a communication device (for example, a network device). The communication chip may include a transmitter configured to send information, and a receiver configured to receive information or data.

According to a seventh aspect, a communication device is provided. The communication device includes a processor and a memory. The memory is configured to store a computer program. The processor is configured to: invoke the computer program from the memory and run the computer program, to enable the communication device to perform the communication method in the first aspect or the second aspect and the implementations of the first aspect or the second aspect.

Optionally, there are one or more processors, and there are one or more memories.

Optionally, the memory may be integrated with the processor, or the memory and the processor are separately configured.

Optionally, the communication device further includes a transmitter (transmitting device) and a receiver (receiving device).

According to an eighth aspect, a communication device is provided. The communication device includes a processor and a memory. The memory is configured to store a computer program. The processor is configured to: invoke the computer program from the memory and run the computer program, to enable the communication device to perform the communication method in the third aspect or the fourth aspect and the implementations of the third aspect or the fourth aspect.

Optionally, there are one or more processors, and there are one or more memories.

Optionally, the memory may be integrated with the processor, or the memory and the processor are separately configured.

Optionally, the communication device further includes a transmitter (transmitting device) and a receiver (receiving device).

According to a ninth aspect, a computer program product is provided. The computer program product includes a computer program (which may also be referred to as code or instructions). When the computer program is run, a computer is enabled to perform the communication method in any one of the first aspect to the fourth aspect or the implementations of any one of the first aspect to the fourth aspect.

According to a tenth aspect, a communication system is provided. The system includes at least one apparatus configured to perform the method in the first aspect and the implementations of the first aspect.

Optionally, the communication system further includes at least one apparatus configured to perform the method in the third aspect and the implementations of the third aspect.

According to an eleventh aspect, a communication system is provided. The system includes at least one apparatus configured to perform the method in the third aspect and the implementations of the third aspect.

Optionally, the communication system further includes at least one apparatus configured to perform the method in the first aspect and the implementations of the first aspect.

According to a twelfth aspect, a communication system is provided. The system includes at least one apparatus configured to perform the method in the second aspect and the implementations of the second aspect.

Optionally, the communication system further includes at least one apparatus configured to perform the method in the fourth aspect and the implementations of the fourth aspect.

According to a thirteenth aspect, a communication system is provided. The system includes at least one apparatus configured to perform the method in the fourth aspect and the implementations of the fourth aspect.

Optionally, the communication system further includes at least one apparatus configured to perform the method in the second aspect and the implementations of the second aspect.

According to a fourteenth aspect, a chip system is provided. The chip system includes a memory and a processor. The memory is configured to store a computer program. The processor is configured to: invoke the computer program from the memory and run the computer program, to enable a communication device in which the chip system is installed to perform the communication method in any one of the foregoing aspects and the implementations of the foregoing aspects.

The chip system may include an input circuit or an interface configured to send information or data, and an output circuit or an interface configured to receive information or data.

### BRIEF DESCRIPTION OF DRAWINGS

FIG. 1 is a schematic diagram of a left-hand circularly polarized wave and a right-hand circularly polarized wave;

FIG. 2 is a schematic diagram of polarization crosstalk between mutually orthogonal electromagnetic waves according to an embodiment;

FIG. 3 is a schematic diagram of a method for calculating cross-polarization discrimination and cross-polarization isolation;

FIG. 4 is a schematic diagram of a system architecture according to an embodiment;

FIG. 5 is a schematic diagram of an example of a communication method according to an embodiment;

FIG. 6 is a schematic diagram of another example of a communication method according to an embodiment;

FIG. 7 is a schematic diagram of still another example of a communication method according to an embodiment;

FIG. 8 is a schematic diagram of an example of a communication apparatus according to an embodiment; and

FIG. 9 is a schematic diagram of another example of a communication apparatus according to an embodiment.

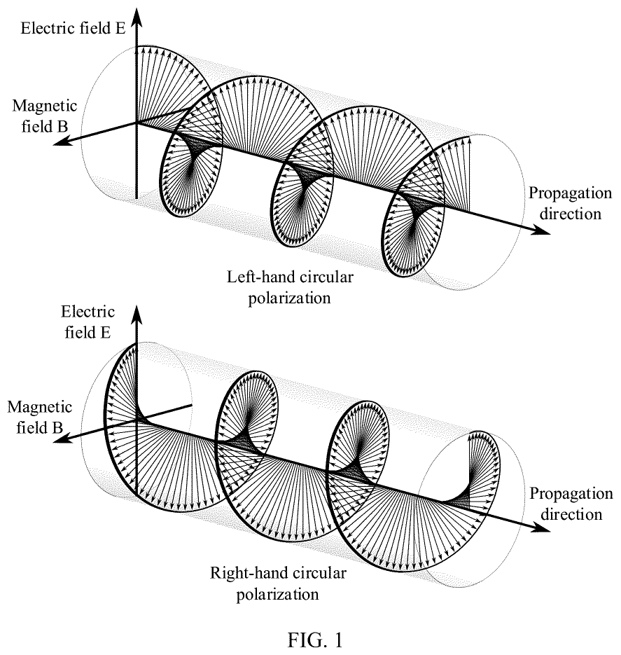

### DETAILED DESCRIPTION OF EMBODIMENTS

The following describes solutions of embodiments with reference to accompanying drawings.

The solutions in embodiments may be applied to various communication systems, for example, a global system for mobile communications (GSM) system, a code division multiple access (CDMA) system, a wideband code division multiple access (WCDMA) system, a general packet radio service (GPRS), a long term evolution (LTE) system, an LTE frequency division duplex (FDD) system, LTE time division duplex (TDD) system, a universal mobile telecommunications system (UMTS), a worldwide interoperability for microwave access (WiMAX) communication system, a 5th generation (5G) system, a 6th generation (6G) system, a new radio (NR) system, a future next generation wireless communication system, or the like; and a non-terrestrial network system, including a satellite communication system and a high altitude platform station (HAPS) communication system, for example, an integrated communication and navigation (IcaN) system, a global navigation satellite system (GNSS), and an ultra-dense low-orbit satellite communication system. The satellite communication system may be integrated with a conventional mobile communication system.

A terminal device in embodiments may be user equipment (UE), an access terminal, a subscriber unit, a subscriber station, a mobile station, a remote station, a remote terminal, a mobile device, a user terminal, a terminal, a wireless communication device, a user agent, or a user apparatus. The terminal device may alternatively be a cellular phone, a cordless phone, a session initiation protocol (SIP) phone, a wireless local loop (WLL) station, a personal digital assistant (PDA), a handheld device having a wireless communication function, a computing device, another processing device connected to a wireless modem, a vehicle-mounted device, a wearable device, a terminal device in a 5G network, a terminal device in an evolved public land mobile network (PLMN), or the like. This is not limited.

A network device in embodiments may be a device configured to communicate with the terminal device. The network device may be a base transceiver station (BTS) in a global system for mobile communications (GSM) or code division multiple access (CDMA) system, a NodeB (NB) in a wideband code division multiple access (WCDMA) system, an evolved NodeB (eNB or eNodeB) in an LTE system, or a radio controller in a cloud radio access network (CRAN) scenario. Alternatively, the network device may be a relay station, an access point, a vehicle-mounted device, a wearable device, a network device in a 5G network, a network device in an evolved PLMN network, a network device in a future 6G network, or the like. This is not limited in embodiments.

It should be noted that a polarization multiplexing mechanism may be classified into polarization multiplexing between terminal devices inter-UE and polarization multiplexing in a terminal device intra-UE.

It should be understood that polarization multiplexing may also be referred to as cross-polarization multiplexing. Polarization multiplexing means that a terminal device or a network device receives or sends data in a pair of orthogonal polarization directions on a same space domain resource, frequency domain resource, and time domain resource.

It should be noted that a name of polarization multiplexing is not limited in embodiments, and may also be referred to as cross-polarization multiplexing, or another name, provided that a corresponding meaning is expressed.

Polarization multiplexing between terminal devices is to allocate, to different terminal devices, resources that are in same frequency domain, same time domain, and same space domain and that are transmitted in mutually orthogonal polarization directions, so that polarization multiplexing between different terminal devices is implemented for the resources in same frequency domain, same time domain, and same space domain.

For example, a pair of a left-hand circularly polarized resource and a right-hand circularly polarized resource in same frequency domain, same time domain, and same space domain may be allocated to a terminal device 1 and a terminal device 2.

For another example, a pair of a horizontally polarized resource and a vertically polarized resource in same frequency domain, same time domain, and same space domain may be allocated to the terminal device 1 and the terminal device 2.

For another example, a pair of a positive 45-degree polarized resource and a negative 45-degree polarized resource in same frequency domain, same time domain, and same space domain may be allocated to the terminal device 1 and the terminal device 2.

Polarization multiplexing in a terminal device is to allocate, to a same terminal device, resources that are in same frequency domain, same time domain, and same space domain and that are transmitted in mutually orthogonal polarization directions. For example, different polarization directions are mutually orthogonal polarization directions, so that polarization multiplexing in a same terminal device is implemented for resources in same frequency domain, same time domain, and same space domain.

For example, a pair of a left-hand circularly polarized resource and a right-hand circularly polarized resource in same frequency domain, same time domain, and same space domain may be allocated to a same terminal device. For another example, a pair of a horizontally polarized resource and a vertically polarized resource in same frequency domain, same time domain, and same space domain may be allocated to the same terminal device. For another example, a pair of a positive 45-degree polarized resource and a negative 45-degree polarized resource in same frequency domain, same time domain, and same space domain may be allocated to the same terminal device.

It should be understood that a link coverage capability, link stability, and a link throughput capability for a terminal device can be improved by using the polarization multiplexing mechanism, signal interference between terminal devices can be avoided by using the polarization multiplexing mechanism, and a data throughput of a single terminal device can also be improved by using the polarization multiplexing mechanism.

It should be noted that, in embodiments, a polarization multiplexing mechanism in a terminal device is described, that is, a pair of resources that are in same frequency domain, same time domain, and same space domain and that are transmitted in mutually orthogonal polarization directions are allocated to a same terminal device.

However, in some cases, the solutions described in embodiments may also be applied to polarization multiplexing between terminal devices. This is not limited in embodiments.

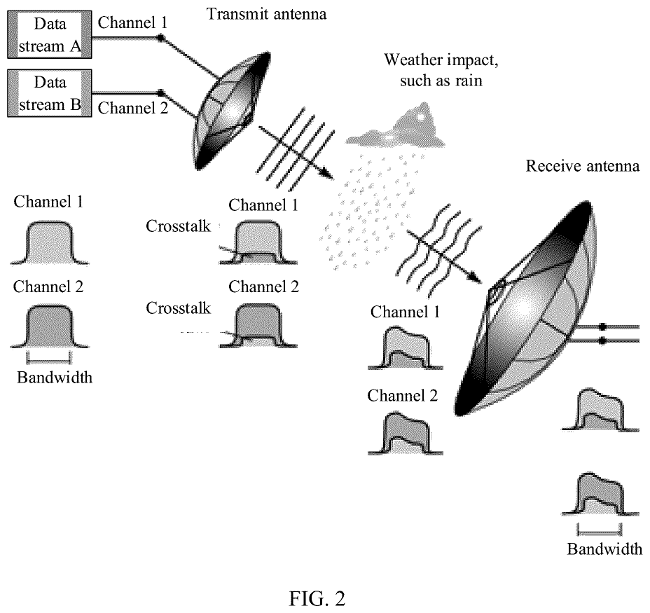

The following describes polarization crosstalk between mutually orthogonal electromagnetic waves with reference to FIG. 2. FIG. 2 is a schematic diagram of polarization crosstalk between mutually orthogonal electromagnetic waves according to an embodiment.

In an ideal status, resources that are in same time domain, same frequency domain, and same space domain and that are transmitted in mutually orthogonal polarization directions do not interfere with each other. However, an electromagnetic wave propagated through atmosphere may be depolarized, attenuated, and phase-shifted.

Depolarization of the electromagnetic wave means a change of a polarization characteristic of the electromagnetic wave during propagation in the atmosphere.

Depolarization may occur in both linearly and circularly polarized systems.

Main reasons for depolarization are rainfall in a path, high-altitude ice particles in the path, and multipath propagation.

When the electromagnetic wave degrades, a depolarization phenomenon occurs. Consequently, the polarization characteristic changes.

A polarization state of a depolarized electromagnetic wave changes, so that power of the depolarized electromagnetic wave is transferred from a required polarization state to an undesired orthogonal polarization state. As a result, interference or crosstalk occurs between two orthogonal polarized channels.

For example, in a frequency band above about 12 gigahertz GHz, rainwater and ice are two important causes of a depolarization problem.

As shown in FIG. 2, an antenna of a satellite transmits an independent data stream A on a channel land an independent data stream Ba channel 2.

It should be noted that the data stream A and the data stream B share a common time domain resource, space domain resource, and frequency domain resource.

A transmit antenna of the satellite generates a left-hand circularly polarized electromagnetic wave and a right-hand circularly polarized electromagnetic wave that are almost independent. The left-hand circularly polarized electromagnetic wave transmits the data stream A on the channel 1, and the right-hand circularly polarized electromagnetic wave transmits the data stream B on the channel 2.

Due to normal physical tolerance limitation and hardware defects of the transmit antenna, a small amount of pollution or crosstalk occurs between left-hand circularly polarized and right-hand circularly polarized transmission signals.

Therefore, some signals of the data stream A appear on the right-hand circularly polarized channel 2 (a channel that originally the data stream B is transmitted), and some signals of the data stream B appear on the left-hand circularly polarized channel 1 (a channel that originally the data stream A is transmitted).

In addition, a left-hand circularly polarized wave and a right-hand circularly polarized wave undergo attenuation, phase shift, and depolarization during propagation in damp, rainy, and turbulent atmosphere.

Therefore, when a signal reaches a receive antenna, an amplitude and a phase of the signal may be distorted to some extent, and a degree of crosstalk between a left-hand circularly polarized component and a right-hand circularly polarized component increases due to impact of environmental factors.

In signals output by the receive antenna, due to a non-ideal characteristic of the receive antenna, a signal output to a receiver undergoes more signal amplitude distortion, phase distortion, and crosstalk.

Weather has different degrees of impact on different polarization manners, and different weather conditions also have different impact on depolarization. For example, when it is raining, impact on signals in different polarization directions varies with an inclination angle of a raindrop.

In some situations, cross-polarization discrimination (XPD) and cross-polarization isolation (I) indicate a degree of polarization crosstalk.

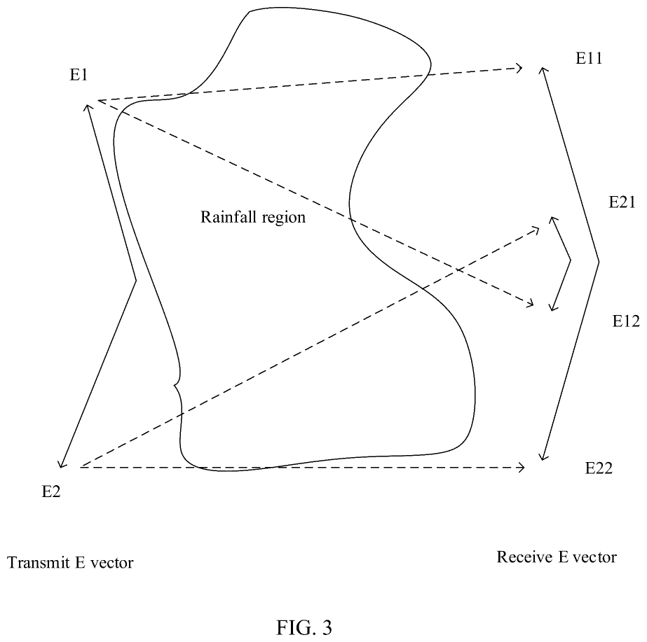

FIG. 3 is a schematic diagram of a method for calculating cross-polarization discrimination and cross-polarization isolation.

As shown in FIG. 3, a calculation formula for the XPD is:

$$X P {D}_{1} = 20 log \frac{\vert {E}_{11} \vert}{\vert {E}_{12} \vert}$$

$$XP {D}_{2} = 20 log \frac{\vert {E}_{22} \vert}{\vert {E}_{21} \vert}$$

A calculation formula for the I is:

$${I}_{1} = 20 log \frac{\vert {E}_{11} \vert}{\vert {E}_{21} \vert}$$

$${I}_{2} = 20 log \frac{\vert {E}_{22} \vert}{\vert {E}_{12} \vert}$$

A smaller value of the cross-polarization discrimination or cross-polarization isolation indicates more serious crosstalk. However, serious crosstalk interferes with operating of a receiver. This causes the receiver to fail to operate normally.

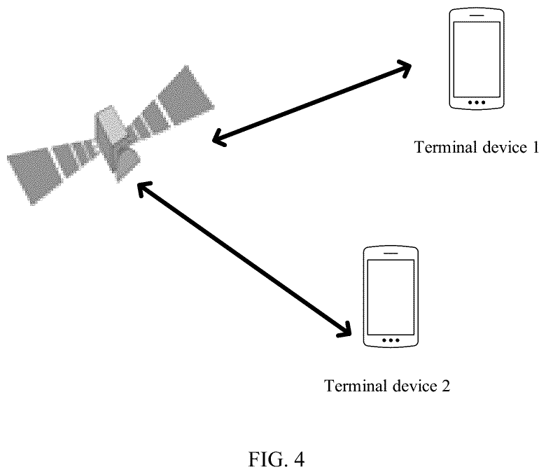

FIG. 4 is a schematic diagram of a system architecture according to an embodiment.

As shown in FIG. 4, an embodiment may be applied to an NTN system. The system includes a satellite base station and a terminal device. The satellite base station may provide a communication service for the terminal device. The satellite base station transmits downlink data to the terminal device. The downlink data is encoded through channel encoding. After constellation modulation is performed on the data on which channel encoding has been performed, the data is transmitted to the terminal device. The terminal device transmits uplink data to the satellite base station. The uplink data may also be encoded through channel encoding. After constellation modulation is performed on the encoded data, the data is transmitted to the satellite base station.

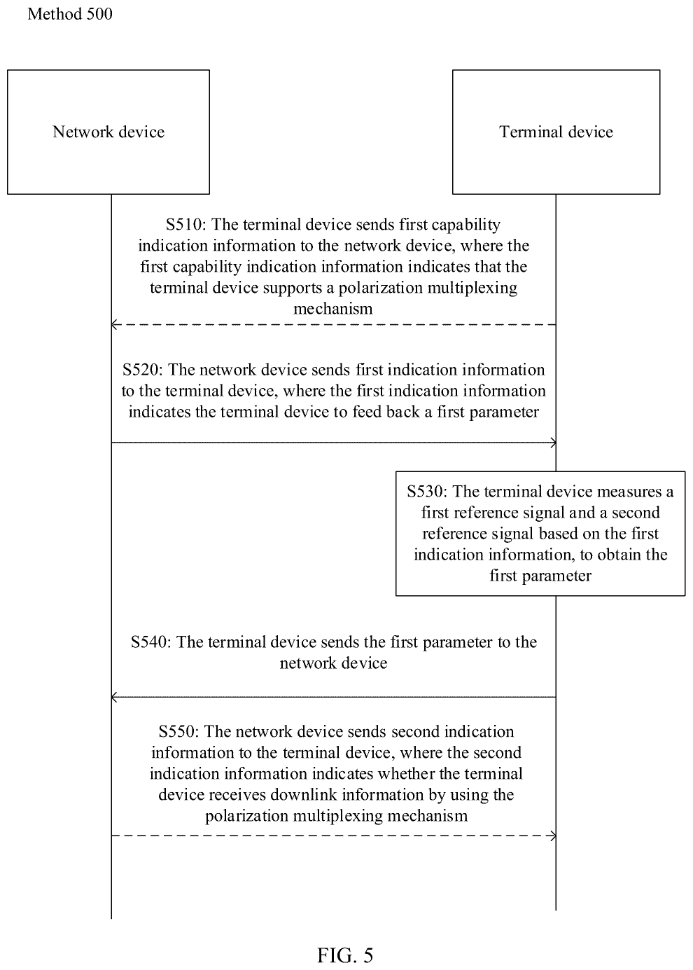

FIG. 5 is a schematic diagram of an example of a communication method according to an embodiment. As shown in FIG. 5, a network device indicates a terminal device to feed back a degree of polarization crosstalk between downlink channels, and determines, based on the degree of crosstalk, whether to transmit downlink data by using a polarization multiplexing mechanism. The method 500 includes the following steps.

S510: The terminal device sends first capability indication information to the network device, where the first capability indication information indicates that the terminal device supports the polarization multiplexing mechanism.

It should be understood that the polarization multiplexing mechanism in this embodiment is a polarization multiplexing mechanism in a terminal device. In other words, for a same terminal device, downlink data or uplink data is transmitted in mutually orthogonal polarization directions in same frequency domain, same time domain, and same space domain.

It should be noted that, this step may be understood as that the terminal device reports a capability to the network device, to report whether the terminal device has a polarization multiplexing capability, whether the terminal device supports the polarization multiplexing mechanism, or whether the terminal device supports receiving of downlink data on mutually orthogonal channels.

Alternatively, when this step is combined with a method 600, the terminal may report a capability, to report whether the terminal device has a polarization multiplexing capability or whether the terminal device supports the polarization multiplexing mechanism. That the terminal device has the polarization multiplexing capability or supports the polarization multiplexing mechanism may be that the terminal device has uplink and downlink polarization multiplexing capabilities or supports uplink and downlink polarization multiplexing mechanisms. Alternatively, in other words, the terminal device supports receiving of downlink data or sending of uplink data on mutually orthogonal channels.

It should be understood that, when receiving of downlink data is considered, that the terminal device supports the polarization multiplexing mechanism may be that the terminal device has a receive antenna for receiving reference signals transmitted in a first polarization direction and a second polarization direction, or the terminal device has a receiver for receiving reference signals transmitted in a first polarization direction and a second polarization direction.

It should be understood that, when this step is combined with the method 600, that the terminal device supports the polarization multiplexing mechanism may be that the terminal device has a receive antenna for receiving reference signals transmitted in mutually orthogonal polarization directions, and also has a transmit antenna for sending reference signals transmitted in mutually orthogonal polarization directions. Alternatively, the terminal device has a receiver for receiving reference signals transmitted in mutually orthogonal polarization directions, and also has a transmitter for sending reference signals transmitted in mutually orthogonal polarization directions.

It should be understood that the channel in this embodiment may alternatively be a link, a beam, or the like.

It should be understood that this step is optional.

The terminal device may not need to send the first capability indication information to the network device.

In a possible implementation, the network device considers, by default, that the terminal device supports the polarization multiplexing mechanism.

In another possible implementation, the network device performs step S520 without sensing whether the terminal device supports the polarization multiplexing mechanism. A difference is that when the terminal device does not support the polarization multiplexing mechanism, after the network device performs step S520, the network device does not receive feedback from the terminal device in a preset feedback time window, or the network device receives a specific value fed back by the terminal device, where the specific value indicates that the terminal device does not have the polarization multiplexing capability, or the network device receives a value that is fed back by the terminal device and that indicates a serious degree of polarization crosstalk, to notify the network device not to use the polarization multiplexing mechanism for the terminal device.

S520: The network device sends first indication information to the terminal device, where the first indication information indicates the terminal device to feed back a first parameter.

Correspondingly, the terminal device receives the first indication information sent by the network device.

The first parameter indicates a degree of crosstalk between a first reference signal and a second reference signal.

The first reference signal and the second reference signal are transmitted on a first time domain resource, a first frequency domain resource, and a first space domain resource. The first reference signal is transmitted in a first polarization direction, the second reference signal is transmitted in a second polarization direction, and the first polarization direction and the second polarization direction are two mutually orthogonal polarization directions used for the polarization multiplexing mechanism.

Optionally, the first polarization direction may be left-hand circular polarization, and the second polarization direction may be right-hand circular polarization.

Optionally, the first polarization direction may be horizontal linear polarization, and the second polarization direction may be vertical linear polarization.

Optionally, the first polarization direction may be positive 45-degree polarization, and the second polarization direction may be negative 45-degree polarization.

It should be understood that polarization directions of the first polarization direction and the second polarization direction are determined based on a type of an antenna used by the network device to send downlink information to the terminal device.

It should be understood that a type of a receive antenna of the terminal device adapts to a type of a transmit antenna of the network device. In other words, that the terminal device supports the polarization multiplexing mechanism may also be understood as that the terminal device has the receive antenna that adapts to the transmit antenna of the network device and that receives signals transmitted in orthogonal polarization directions.

Optionally, the network device may indicate the terminal device to feed back first parameters of a plurality of pairs of mutually orthogonal reference signals.

Optionally, the first reference signal and the second reference signal have a low cross-correlation and a high auto-correlation, so that a degree of crosstalk obtained through measurement reflects only a channel status as much as possible, and a measurement result is more accurate.

Optionally, the first reference signal and the second reference signal may be generated based on a pseudo-random sequence signal pair, and sequence initialization values corresponding to the first reference signal and the second reference signal are different from sequence initialization values corresponding to the pseudo-random sequence signal pair.

It should be understood that, the first reference signal and the second reference signal may be directly generated in an existing manner of generating the pseudo-random sequence signal pair. A difference is that initialization values for generating the pseudo-random sequence signal pair are modified. The method for generating the first reference signal and the second reference signal is simple with small modification based on the existing manner.

For example, the pseudo-random sequence signal pair may be an orthogonal pair of DMRSs on an SS/PBCH.

An initial manner of generating the second m random sequence of a Gold sequence of the DMRSs is set to be different from an existing manner. For example, the second m random sequence satisfies:

$${c}_{init} = {\sum }_{i = 0}^{30} {x}_{2} ( i ) \cdot {2}^{i}$$

When the first reference signal and the second reference signal are generated, cᵢₙᵢₜ is modified to cᵢₙᵢₜ+D. Optionally, D indicates a polarization direction. When corresponding to the first polarization direction, D is set to 0. When corresponding to the second polarization direction, D is set to 1.

Optionally, the first time domain resource, the first frequency domain resource, the first space domain resource, the first polarization direction, and the second polarization direction are preconfigured by the network device for the terminal device.

Optionally, the first indication information includes configurations of the first time domain resource, the first frequency domain resource, the first space domain resource, the first polarization direction, and the second polarization direction. The terminal device receives the first indication information, that is, measures, by default, the first reference signal and the second reference signal on resources and in polarization directions configured by using the first indication information, to obtain the first parameter. Optionally, the first indication information may be sent by using a SIB. Optionally, the first indication information may be sent by using RRC signaling.

Optionally, before the terminal device receives the first indication information sent by the network device, the terminal device receives resource configuration information sent by the network device. The resource configuration information is used to configure the first time domain resource, the first frequency domain resource, the first space domain resource, the first polarization direction, and the second polarization direction.

Optionally, before the terminal device receives the first indication information sent by the network device, the terminal device receives resource configuration information sent by the network device. The resource configuration information is used to configure some configurations of the first time domain resource, the first frequency domain resource, the first space domain resource, the first polarization direction, and the second polarization direction. The first indication information may include remaining configurations of the first time domain resource, the first frequency domain resource, the first space domain resource, the first polarization direction, and the second polarization direction, and is used to activate the terminal device to measure the first reference signal and the second reference signal, to obtain the first parameter.

Optionally, the resource configuration information may be sent by using a system broadcast message (SIB).

Optionally, the resource configuration information may be sent by using radio resource control (RRC) signaling.

Optionally, the first indication information may be media access control-CE (MAC-CE) information.

Optionally, the first indication information may be downlink control information (DCI).

It should be noted that the first indication information and/or the resource configuration information are/is transmitted in the first polarization direction or the second polarization direction. Optionally, a transmission polarization direction of the first indication information and/or the resource configuration information is preconfigured by the network device. Optionally, the transmission polarization direction of the first indication information and/or the resource configuration information is indicated by the network device to the terminal device by using indication information. The indication information may be sent by using broadcast signaling or dedicated indication signaling, or may be indirectly sent by using SSB or information included in a BWP (bandwidth part).

S530: The terminal device measures the first reference signal and the second reference signal based on the first indication information, to obtain the first parameter.

That the terminal device measures the first reference signal and the second reference signal may be at least one of the following:

The terminal device measures first signal energy and second signal energy;
the terminal device measures third signal energy and fourth signal energy;
the terminal device measures the first signal energy and the fourth signal energy; or
the terminal device measures the second signal energy and the third signal energy.

It should be understood that items that are to be measured by the terminal device are determined based on the first parameter fed back by the terminal device. An example is used below for description.

The first signal energy is energy of the first reference signal in the first polarization direction, the second signal energy is energy of the second reference signal in the first polarization direction, the third signal energy is energy of the second reference signal in the second polarization direction, and the fourth signal energy is energy of the first reference signal in the second polarization direction.

The first parameter includes at least one of the following:
the first signal energy and the second signal energy;
the third signal energy and the fourth signal energy;
the first signal energy and the fourth signal energy;
the second signal energy and the third signal energy;
first cross-polarization discrimination (XPD1) corresponding to the first reference signal;
second cross-polarization discrimination (XPD2) corresponding to the second reference signal;
first cross-polarization isolation (I1) corresponding to the first reference signal;
second cross-polarization isolation (I2) corresponding to the second reference signal;
a result of comparison between the XPD1 and a first preset value;
a result of comparison between the XPD2 and the first preset value;
a result of comparison between the I1 and a second preset value; or
a result of comparison between the I2 and the second preset value.

Optionally, the terminal device may determine the first parameter, to directly feed back indication information to the network device. The indication information indicates the network device not to send downlink information to the terminal device by using the polarization multiplexing mechanism.

The XPD1 is determined based on a ratio of the first signal energy to the fourth signal energy. For example,

$$X P D 1 = 20 log \frac{\vert first signal energy \vert}{\vert fourth signal energy \vert}$$

The XPD2 is determined based on a ratio of the third signal energy to the second signal energy. For example,

$$X P D 2 = 20 log \frac{\vert third signal energy \vert}{\vert second signal energy \vert}$$

The I1 is determined based on a ratio of the first signal energy to the second signal energy. For example,

$$I 1 = 20 log \frac{\vert first signal energy \vert}{\vert second signal energy \vert}$$

The I2 is determined based on a ratio of the third signal energy to the fourth signal energy. For example,

$$I 2 = 20 log \frac{\vert third signal energy \vert}{\vert fourth signal energy \vert}$$

By way of example, the terminal device may measure only some signal energy instead of measuring all signal energy.

For example, the terminal device measures the first signal energy and the second signal energy. If the first signal energy and the second signal energy reflect that the first reference signal cannot be normally transmitted, or information cannot be transmitted to the terminal device due to a degree of crosstalk of the second reference signal to the first reference signal, it indicates that signal transmission by using the polarization multiplexing mechanism does not implement expected beneficial impact on an entire link. Therefore, the terminal device measures only the first signal energy and the second signal energy and feeds back only the first signal energy and the second signal energy to the network device, or feeds back only the I1 to the network device, or feeds back only the result of comparison between the I1 and the second preset value to the network device, so that the network device can determine that the polarization multiplexing mechanism is not suitable for transmitting the downlink information.

S540: The terminal device sends the first parameter to the network device.

Correspondingly, the network device receives the first parameter sent by the terminal device.

Optionally, the terminal device may feed back the first parameter by using a newly added field in a CSI-Report.

Optionally, the newly added field is indicated by the network device or preconfigured by the network device.

S550: The network device sends second indication information to the terminal device, where the second indication information indicates whether the terminal device receives the downlink information by using the polarization multiplexing mechanism.

It should be noted that, similar to the first indication information and/or the resource configuration information, the second indication information is transmitted in the first polarization direction or the second polarization direction.

In other words, the second indication information is transmitted in a preconfigured or indicated polarization direction.

It should be noted that this step is optional.

The network device receives the first parameter sent by the terminal device, determines a degree of crosstalk between the first reference signal and the second reference signal based on the first parameter, and further determines whether using the polarization multiplexing mechanism in the first polarization direction and the second polarization direction is beneficial to running of the entire link.

For example, if crosstalk between the first reference signal and the second reference signal is excessively large, the entire system cannot work normally, and use of polarization multiplexing does not make sense.

Optionally, when the network device determines not to use polarization multiplexing, the network device may send the second indication information to the terminal device.

Optionally, the second indication information may indicate the terminal device not to receive the downlink information by using the polarization multiplexing mechanism. Correspondingly, the terminal device may continue to receive the downlink information in a polarization direction, by default, in which the first indication information and/or the resource configuration information are/is received.

Optionally, if the terminal device has received the downlink information by using the polarization multiplexing mechanism before receiving the first indication information, the second indication information may indicate the terminal device to end the polarization multiplexing mechanism, or the second indication information may indicate the terminal device to update a current polarization state. The updating the current polarization state may be updating a polarization direction to the polarization multiplexing mechanism or updating the polarization multiplexing mechanism to a polarization direction. The polarization direction may be a default polarization direction, a preconfigured polarization direction, or a polarization direction indicated by indication information. Correspondingly, the terminal device may continue to receive the downlink information in a polarization direction, by default, in which the first indication information and/or the resource configuration information are/is received.

Optionally, the second indication information may indicate the terminal device to receive the downlink information in the first polarization direction or the second polarization direction. Correspondingly, the terminal device continues to receive the downlink information in the first polarization direction or the second polarization direction.

Optionally, when the network device determines not to use polarization multiplexing, the network device may not send the second indication information to the terminal device. Correspondingly, the terminal device may continue to receive the downlink information in a polarization direction, by default, in which the first indication information and/or the resource configuration information are/is received, or the terminal device may continue to receive the downlink information in a preconfigured polarization direction.

Optionally, when the network device determines to use polarization multiplexing, the network device may send the second indication information to the terminal device.

Optionally, the second indication information may indicate the terminal device to receive the downlink information by using the polarization multiplexing mechanism. Correspondingly, the terminal device receives the downlink information through polarization multiplexing.

Optionally, if the downlink information has been received by using the polarization multiplexing mechanism before the first indication information is received, the second indication information may indicate the terminal device to maintain the polarization multiplexing mechanism or maintain a polarization state. Correspondingly, the terminal device receives the downlink information through polarization multiplexing.

Correspondingly, the terminal device receives the downlink information based on an indication of the network device or a default configuration.

According to the communication method provided in this embodiment, the network device indicates the terminal device to measure a degree of crosstalk between reference signals transmitted in mutually orthogonal polarization directions on a same frequency domain resource, a same time domain resource, and a same space domain resource. When the degree of crosstalk can meet a link requirement, the network device indicates the terminal device to receive downlink information in a polarization multiplexing manner. This can ensure stability of an entire link after polarization multiplexing is enabled. In addition, data is transmitted in the polarization multiplexing manner, so that a link throughput can be improved, system communication efficiency can be improved, and spectrum resources can be reduced.

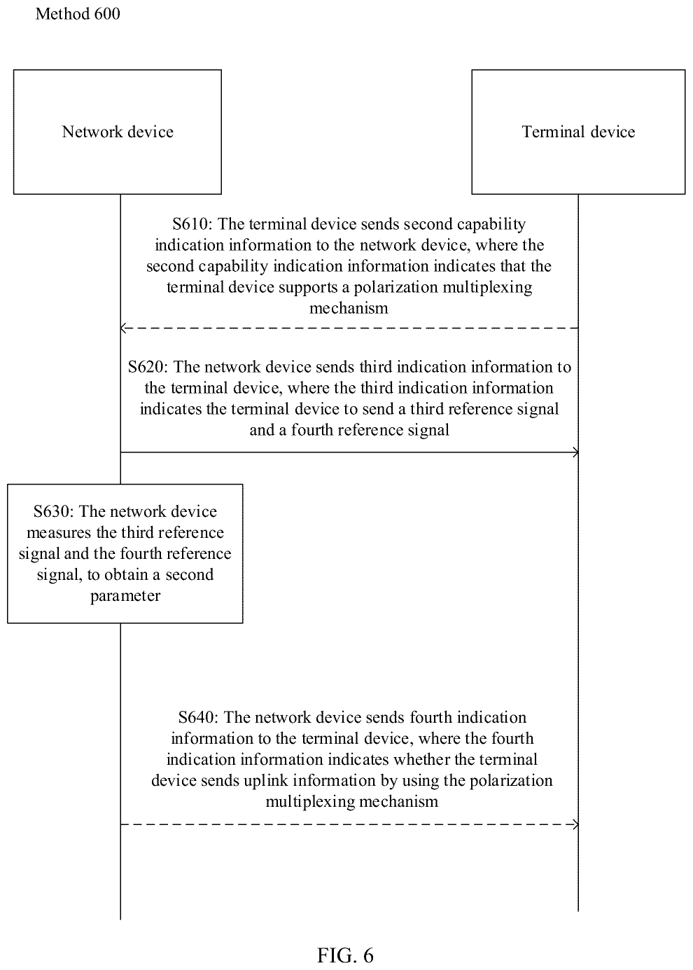

FIG. 6 is a schematic diagram of another example of a communication method according to an embodiment. As shown in FIG. 6, a network device indicates a terminal device to send a third reference signal and a fourth reference signal to the network device, obtains, through measurement, a degree of polarization crosstalk of an uplink channel corresponding to the third reference signal and the fourth reference signal, and determines, based on the degree of crosstalk, whether to receive uplink data by using a polarization multiplexing mechanism.

It should be noted that the steps of the method 600 may be added before the method 500, the steps of the method 600 may be added after the method 500, and the steps of the method 600 may alternatively be independent of the method 500.

The method 600 includes the following steps.

S610: The terminal device sends second capability indication information to the network device, where the second capability indication information indicates that the terminal device supports the polarization multiplexing mechanism.

It should be understood that the polarization multiplexing mechanism in this embodiment is a polarization multiplexing mechanism in a terminal device. In other words, for a same terminal device, downlink data or uplink data is transmitted in mutually orthogonal polarization directions in same frequency domain, same time domain, and same space domain.

It should be noted that, this step may be understood as that the terminal device reports a capability to the network device, to report whether the terminal device has a polarization multiplexing capability, whether the terminal device supports the polarization multiplexing mechanism, or whether the terminal device supports sending of uplink data on mutually orthogonal channels.

Alternatively, when this step is combined with the method 500, the terminal device may report a capability, to report whether the terminal device has a polarization multiplexing capability or whether the terminal device supports the polarization multiplexing mechanism. That the terminal device has the polarization multiplexing capability or supports the polarization multiplexing mechanism may be that the terminal device has uplink and downlink polarization multiplexing capabilities or supports uplink and downlink polarization multiplexing mechanisms. Alternatively, in other words, the terminal device supports receiving of downlink data or sending of uplink data on mutually orthogonal channels.

It should be understood that, when sending of uplink data is considered, that the terminal device supports the polarization multiplexing mechanism may be that the terminal device has a transmit antenna for sending reference signals transmitted in a third polarization direction and a fourth polarization direction, or the terminal device has a transmitter for sending reference signals transmitted in a third polarization direction and a fourth polarization direction.

It should be understood that, when this step is combined with the method 500, that the terminal device supports the polarization multiplexing mechanism may be that the terminal device has a receive antenna for receiving reference signals transmitted in mutually orthogonal polarization directions, and also has a transmit antenna for sending reference signals transmitted in mutually orthogonal polarization directions. Alternatively, the terminal device has a receiver for receiving reference signals transmitted in mutually orthogonal polarization directions, and also has a transmitter for sending reference signals transmitted in mutually orthogonal polarization directions.

It should be understood that the channel in this embodiment may alternatively be a link, a beam, or the like.

It should be understood that this step is optional.

The terminal device may not need to send the second capability indication information to the network device.

In a possible implementation, the network device considers, by default, that the terminal device supports the polarization multiplexing mechanism.

In another possible implementation, the network device performs step S620 without sensing whether the terminal device supports the polarization multiplexing mechanism. A difference is that when the terminal device does not support the polarization multiplexing mechanism, the network device does not simultaneously receive the third reference signal and the fourth reference signal in S620, the terminal device can send only one of the third reference signal or the fourth reference signal, or the terminal device does not send either of the third reference signal and the fourth reference information signal, and subsequent steps are not performed. Correspondingly, the network device may determine not to receive, by using the polarization multiplexing mechanism, uplink information sent by the terminal device.

S620: The network device sends third indication information to the terminal device, where the third indication information indicates the terminal device to send the third reference signal and fourth reference signal.

Correspondingly, the terminal device receives the third indication information sent by the network device.

The third indication information indicates the terminal device to send the third reference signal and the fourth reference signal to the network device on a second time domain resource, a second frequency domain resource, and a second space domain resource.

The third reference signal is transmitted in a third polarization direction, and the fourth reference signal is transmitted in a fourth polarization direction. The third polarization direction and the fourth polarization direction are two mutually orthogonal polarization directions used for the polarization multiplexing mechanism.

Optionally, the third polarization direction may be left-hand circular polarization, and the fourth polarization direction may be right-hand circular polarization.

Optionally, the third polarization direction may be horizontal linear polarization, and the fourth polarization direction may be vertical linear polarization.

Optionally, the third polarization direction may be positive 45-degree polarization, and the fourth polarization direction may be negative 45-degree polarization.

It should be understood that polarization directions of the third polarization direction and the fourth polarization direction are determined based on a type of an antenna used by the network device to receive uplink information sent by the terminal device.

It should be understood that a type of a receive antenna of the network device adapts to a type of a transmit antenna of the terminal device. In other words, that the terminal device supports the polarization multiplexing mechanism may also be understood as that the terminal device has the transmit antenna that adapts to the receive antenna of the network device and that transmits signals transmitted in orthogonal polarization directions.

Optionally, the network device may indicate the terminal device to send a plurality of pairs of mutually orthogonal reference signals.

Optionally, the third reference signal and the fourth reference signal have a low cross-correlation and a high auto-correlation, so that a degree of crosstalk obtained through measurement reflects only a channel status as much as possible, and a measurement result is more accurate.

It should be understood that, the third reference signal and the fourth reference signal may be directly generated in an existing manner of generating a pseudo-random sequence signal pair. A difference is that initialization values for generating the pseudo-random sequence signal pair are modified. The method for generating the third reference signal and the fourth reference signal is simple with small modification based on the existing manner. Refer to specific descriptions of the example of generating the first reference signal and the second reference signal in the method 500, provided that the first reference signal and the second reference signal are replaced with the third reference signal and the fourth reference signal. Details are not described herein again.

It should be noted that, for configurations of the second time domain resource, the second frequency domain resource, the second space domain resource, the third polarization direction, and the fourth polarization direction, refer to related descriptions of step S520 in the method 500, provided that the first time domain resource is replaced with the second time domain resource, the first frequency domain resource is replaced with the second frequency domain resource, the first space domain resource is replaced with the second space domain resource, the first polarization direction is replaced with the third polarization direction, and the second polarization direction is replaced with the fourth polarization direction. Details are not described herein again.

S630: The network device measures the third reference signal and the fourth reference signal, to obtain a second parameter.

That the network device measures the third reference signal and the fourth reference signal may be at least one of the following:

The network device measures fifth signal energy and sixth signal energy;
the network device measures seventh signal energy and eighth signal energy;
the network device measures the fifth signal energy and the eighth signal energy; or
the network device measures the sixth signal energy and the seventh signal energy.

It should be understood that items that are to be measured by the network device are determined based on the second parameter required by the network device. An example for description is similar to the example of step S530 in the method 500, provided that the terminal device is replaced with the network device, the first signal energy is replaced with the fifth signal energy or the seventh signal energy, and the second signal energy is replaced with the sixth signal energy or the eighth signal energy. Details are not described in this embodiment.

The fifth signal energy is energy of the third reference signal in the third polarization direction, and the sixth signal energy is energy of the fourth reference signal in the third polarization direction. It may also be understood that the sixth signal energy is interference of the fourth reference signal to the third reference signal in the third polarization direction.

The seventh signal energy is energy of the fourth reference signal in the fourth polarization direction, and the eighth signal energy is energy of the third reference signal in the fourth polarization direction. It may also be understood that the eighth signal energy is interference of the third reference signal to the fourth reference signal in the fourth polarization direction.

The second parameter includes at least one of the following:
the fifth signal energy and the sixth signal energy;
the seventh signal energy and the eighth signal energy;
the fifth signal energy and the eighth signal energy;
the sixth signal energy and the seventh signal energy;
third cross-polarization discrimination (XPD3) corresponding to the third reference signal;
fourth cross-polarization discrimination (XPD4) corresponding to the fourth reference signal;
third cross-polarization isolation (I3) corresponding to the third reference signal;
fourth cross-polarization isolation (I4) corresponding to the fourth reference signal;
a result of comparison between the XPD3 and a third preset value;
a result of comparison between the XPD4 and the third preset value;
a result of comparison between the I3 and a fourth preset value; or
a result of comparison between the I4 and the fourth preset value.

The XPD3 is determined based on a ratio of the fifth signal energy to the eighth signal energy. For example,

$$XPD 3 = 20 log \frac{\vert fifth signal energy \vert}{\vert eighth signal energy \vert}$$

The XPD4 is determined based on a ratio of the seventh signal energy to the sixth signal energy. For example,

$$XPD 4 = 20 log \frac{\vert seventh signal energy \vert}{\vert sixth signal energy \vert}$$

The I3 is determined based on a ratio of the fifth signal energy to the sixth signal energy. For example,

$$I 3 = 20 log \frac{\vert fifth signal energy \vert}{\vert sixth signal energy \vert}$$

The I4 is determined based on a ratio of the seventh signal energy to the eighth signal energy. For example,

$$I 4 = 20 log \frac{\vert seventh signal energy \vert}{\vert eighth signal energy \vert}$$

Further, the network device determines, based on the second parameter, whether to receive the uplink information by using the polarization multiplexing mechanism, or whether the terminal device sends the uplink information by using the polarization multiplexing mechanism.

S640: The network device sends fourth indication information to the terminal device, where the fourth indication information indicates whether the terminal device sends the uplink information by using the polarization multiplexing mechanism.

It should be noted that this step is optional.

It should be noted that, similar to the third indication information and/or resource configuration information, the fourth indication information is transmitted in the third polarization direction or the fourth polarization direction.

It should be noted that content of how the network device sends an indication to the terminal device or indicates the terminal device by using the fourth indication information is similar to that of step S550 in the method 500, provided that the downlink information is replaced with the uplink information.

According to the communication method provided in this embodiment, the network device indicates the terminal device to send, to the network device on a same frequency domain resource, a same time domain resource, and a same space domain resource, reference signals transmitted in mutually orthogonal polarization directions. The network device measures a degree of crosstalk between the mutually orthogonal signals. When the degree of crosstalk can meet a link requirement, the network device indicates the terminal device to send uplink information in a polarization multiplexing manner. This can ensure stability of an entire link after polarization multiplexing is enabled. In addition, data is transmitted in the polarization multiplexing manner, so that a link throughput can be improved, system communication efficiency can be improved, and spectrum resources can be reduced.

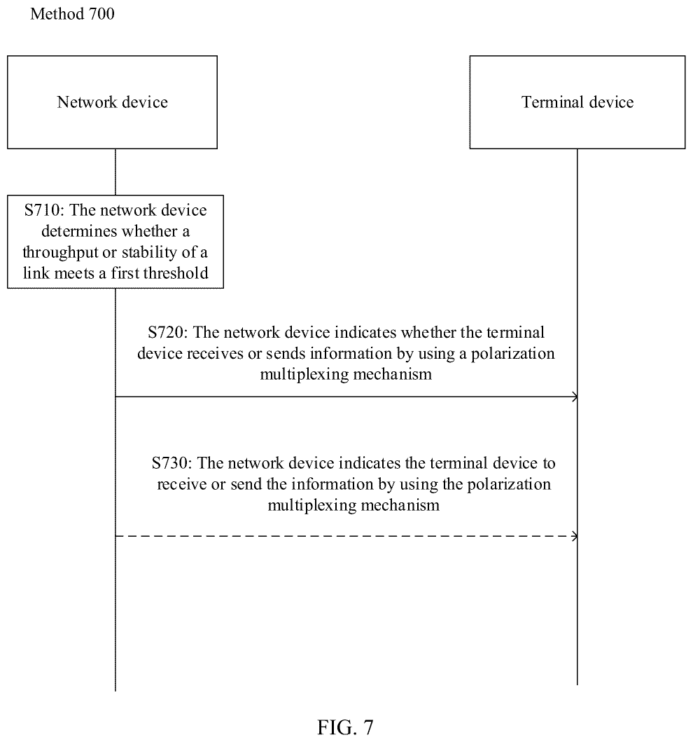

FIG. 7 is a schematic diagram of still another example of a communication method according to an embodiment. In the method shown in FIG. 7, a network device and a terminal device do not measure a reference signal. After enabling an uplink or downlink polarization multiplexing mechanism, the network device evaluates a link status at intervals. If an evaluation result meets a requirement, the network device continues to transmit a signal by using the polarization multiplexing mechanism. If the evaluation result does not meet the requirement, the network device stops transmitting a signal by using the polarization multiplexing mechanism.

The method 700 includes the following steps.

S710: The network device determines whether a throughput or stability of a link meets a first threshold.

It should be understood that before the network device determines whether the throughput or stability of the link meets the first threshold, the network device considers, by default, that the terminal device that supports the polarization multiplexing mechanism receives or sends downlink information or uplink information by using the polarization multiplexing mechanism.

The network device determines, after a first time after the terminal device uses the polarization multiplexing mechanism, whether the throughput or stability of the entire link within the first time reaches the first threshold.

S720: The network device indicates whether the terminal device receives or sends information by using the polarization multiplexing mechanism.

Optionally, if the throughput or stability of the link reaches the first threshold, the network device may send indication information to the terminal device, to indicate the terminal device to continue to receive or send the downlink information or the uplink information by using the polarization multiplexing mechanism.

Optionally, if the throughput or stability of the link reaches the first threshold, the network device may not send indication information to the terminal device, to indicate the terminal device to continue to receive or send the downlink information or the uplink information by using the polarization multiplexing mechanism. The terminal device continues to receive or send the downlink information or the uplink information by using the polarization multiplexing mechanism by default.

Optionally, if the throughput or stability of the link does not reach the first threshold, the network device may send indication information to the terminal device, to indicate the terminal device to stop receiving or sending the downlink information or the uplink information by using the polarization multiplexing mechanism, and receive or send the downlink information or the uplink information by using a default polarization direction, a polarization direction preconfigured by the network device, or a polarization direction indicated by the network device.

S730: The network device indicates the terminal device to receive or send the information by using the polarization multiplexing mechanism.

It should be noted that this step is optional.

In step S720, after the network device indicates the terminal device to stop receiving or sending the downlink information or the uplink information by using the polarization multiplexing mechanism, after a second time, the network device may indicate the terminal device to receive or send the downlink information or the uplink information again by using the polarization multiplexing mechanism.

Further, the network device may repeat step S710 and step S720.

Optionally, after the second time, the network device may directly indicate the terminal device to receive or send the downlink information or the uplink information again by using the polarization multiplexing mechanism.

Optionally, after the second time, when an air interface resource is idle, the network device may indicate the terminal device to receive or send the downlink information or the uplink information again by using the polarization multiplexing mechanism.

According to the communication method provided in this embodiment, communication performance, such as a throughput or stability, is directly observed, to determine whether using the polarization multiplexing mechanism is conducive to improving system performance, and whether to continue to use a working manner of the polarization multiplexing mechanism. This helps select a most appropriate working manner for the system and improve the system performance.

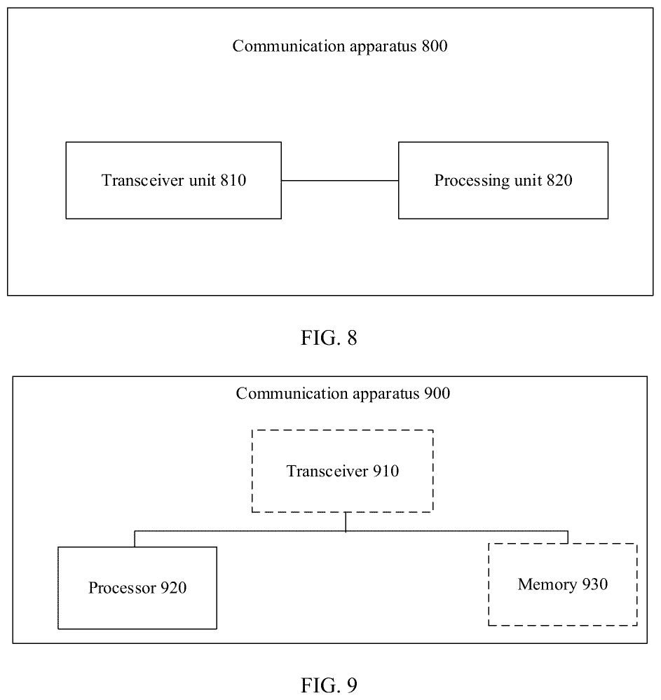

FIG. 8 is a schematic diagram of an example of a communication apparatus according to an embodiment. As shown in FIG. 8, the communication apparatus 800 includes a transceiver unit 810 and a processing unit 820.

In some embodiments, the communication apparatus 800 may be configured to implement functions of the terminal device in the foregoing method 500. For example, the communication apparatus 800 may correspond to the terminal device.

The communication apparatus 800 may be a terminal device and perform the steps performed by the terminal device in the foregoing method 500. The transceiver unit 810 may be configured to support the communication apparatus 800 in performing communication, for example, performing a sending and/or receiving action performed by the terminal device in the foregoing method 500. The processing unit 820 may be configured to support the communication apparatus 800 in performing a processing action in the foregoing method embodiment, for example, performing a processing action performed by the terminal device in the foregoing method 500.

Optionally, the communication apparatus may further include a storage unit 830 (not shown in FIG. 8), configured to store program code and data of the communication apparatus.

For details, refer to the following descriptions.

The transceiver unit 810 is configured to receive first indication information from a network device.

The processing unit 820 is configured to determine a first parameter.

The first indication information indicates the transceiver unit 810 to feed back the first parameter, and the first parameter indicates a degree of crosstalk between a first reference signal and a second reference signal.

The first reference signal and the second reference signal are transmitted on a first time domain resource, a first frequency domain resource, and a first space domain resource, the first reference signal is transmitted in a first polarization direction, and the second reference signal is transmitted in a second polarization direction.

The first polarization direction and the second polarization direction are two mutually orthogonal polarization directions used for a polarization multiplexing mechanism.

The processing unit 820 is further configured to measure the first reference signal and the second reference signal based on the first indication information, to obtain the first parameter.

The transceiver unit 810 is further configured to send the first parameter to the network device.

The transceiver unit 810 is further configured to send first capability indication information to the network device.

The first capability indication information is that the terminal device reports a capability to the network device. The first capability indication information indicates that the terminal device supports the polarization multiplexing mechanism, that is, the terminal device has a receive antenna for receiving reference signals transmitted in the first polarization direction and the second polarization direction.

Optionally, the first polarization direction may be left-hand circular polarization, and the second polarization direction may be right-hand circular polarization.

Optionally, the first polarization direction may be horizontal linear polarization, and the second polarization direction may be vertical linear polarization.

Optionally, the first polarization direction may be positive 45-degree polarization, and the second polarization direction may be negative 45-degree polarization.

That the processing unit 820 measures the first reference signal and the second reference signal includes at least one or more of the following:

The processing unit 820 measures first signal energy and second signal energy;
the processing unit 820 measures third signal energy and fourth signal energy;
the processing unit 820 measures the first signal energy and the fourth signal energy; or
the processing unit 820 measures the second signal energy and the third signal energy.

The first signal energy is energy of the first reference signal in the first polarization direction, the second signal energy is energy of the second reference signal in the first polarization direction, the third signal energy is energy of the second reference signal in the second polarization direction, and the fourth signal energy is energy of the first reference signal in the second polarization direction.

An item or items that is/are to be measured by the processing unit 820 is/are determined by the processing unit 820 based on actual measurement data, or determined by the processing unit 820 based on preconfiguration information of the network device, or determined by the processing unit 820 based on indication information of the network device.

The first parameter includes one or more of the following:
the first signal energy and the second signal energy;
the third signal energy and the fourth signal energy;
the first signal energy and the fourth signal energy;
the second signal energy and the third signal energy;
first cross-polarization discrimination (XPD1) corresponding to the first reference signal, where the XPD1 is determined based on a ratio of the first signal energy to the fourth signal energy;
second cross-polarization discrimination (XPD2) corresponding to the second reference signal, where the XPD2 is determined based on a ratio of the third signal energy to the second signal energy;
first cross-polarization isolation (I1) corresponding to the first reference signal, where the I1 is determined based on a ratio of the first signal energy to the second signal energy;
second cross-polarization isolation (I2) corresponding to the second reference signal, where the I2 is determined based on a ratio of the third signal energy to the fourth signal energy;
a result of comparison between the XPD1 and a first preset value;
a result of comparison between the XPD2 and the first preset value;
a result of comparison between the I1 and a second preset value; or
a result of comparison between the I2 and the second preset value.

It should be noted that smaller values of cross-polarization isolation and cross-polarization discrimination indicate a more serious degree of crosstalk.

The first reference signal and the second reference signal are generated based on a pseudo-random sequence signal pair, and sequence initialization values corresponding to the first reference signal and the second reference signal are different from sequence initialization values corresponding to the pseudo-random sequence signal pair.

The transceiver unit 810 is further configured to receive second indication information sent by the network device, where the second indication information is determined based on the first parameter, and the second indication information indicates whether the transceiver unit 810 receives downlink information by using the polarization multiplexing mechanism.

The transceiver unit 810 determines, based on the second indication information, whether to receive the downlink information by using the polarization multiplexing mechanism.

The first indication information and/or the second indication information are/is transmitted in the first polarization direction, or the first indication information and/or the second indication information are/is transmitted in the second polarization direction.

In some embodiments, the communication apparatus 800 may be configured to implement functions of the terminal device in the foregoing method 600. For example, the communication apparatus 800 may correspond to the terminal device.

The communication apparatus 800 may be a terminal device and perform the steps performed by the terminal device in the foregoing method 600. The transceiver unit 810 may be configured to support the communication apparatus 800 in performing communication, for example, performing a sending and/or receiving action performed by the terminal device in the foregoing method 600. The processing unit 820 may be configured to support the communication apparatus 800 in performing a processing action in the foregoing method embodiment, for example, performing a processing action performed by the terminal device in the foregoing method 600.

Optionally, the communication apparatus may further include a storage unit 830 (not shown in FIG. 8), configured to store program code and data of the communication apparatus.

For details, refer to the following descriptions.

The transceiver unit 810 is configured to receive third indication information.

The processing unit 820 is configured to determine a second parameter.

The third indication information indicates the terminal device to send a third reference signal and a fourth reference signal to the network device on a second time domain resource, a second frequency domain resource, and a second space domain resource, the third reference signal and the fourth reference signal are used by the network device to determine the second parameter, and the second parameter indicates a degree of crosstalk between the third reference signal and the fourth reference signal.

The third reference signal is transmitted in a third polarization direction, the fourth reference signal is transmitted in a fourth polarization direction, and the third polarization direction and the fourth polarization direction are two mutually orthogonal polarization directions used for a polarization multiplexing mechanism.

Optionally, the third polarization direction may be left-hand circular polarization, and the fourth polarization direction may be right-hand circular polarization.

Optionally, the third polarization direction may be horizontal linear polarization, and the fourth polarization direction may be vertical linear polarization.

Optionally, the third polarization direction may be positive 45-degree polarization, and the fourth polarization direction may be negative 45-degree polarization.

The transceiver unit 810 is further configured to receive the third reference signal and the fourth reference signal that are sent by the terminal device.

The transceiver unit 810 is further configured to receive second capability indication information sent by the terminal device, where the second capability indication information is used for capability reporting, and the second capability indication information indicates that the transceiver unit 810 supports the polarization multiplexing mechanism.

It should be understood that, that the transceiver unit 810 supports the polarization multiplexing mechanism may be that the communication apparatus has a transmit antenna for sending reference signals transmitted in the third polarization direction and the fourth polarization direction.

The second parameter includes one or more of the following:
fifth signal energy and sixth signal energy;
seventh signal energy and eighth signal energy;
the fifth signal energy and the eighth signal energy;
the sixth signal energy and the seventh signal energy, where
the fifth signal energy is energy of the third reference signal in the third polarization direction, the sixth signal energy is energy of the fourth reference signal in the third polarization direction, the seventh signal energy is energy of the fourth reference signal in the fourth polarization direction, and the eighth signal energy is energy of the third reference signal in the fourth polarization direction;
third cross-polarization discrimination (XPD3) corresponding to the third reference signal, where the XPD3 is determined based on a ratio of the fifth signal energy to the eighth signal energy;
fourth cross-polarization discrimination (XPD4) corresponding to the fourth reference signal, where the XPD4 is determined based on a ratio of the seventh signal energy to the sixth signal energy;
third cross-polarization isolation (I3) corresponding to the third reference signal, where the I3 is determined based on a ratio of the fifth signal energy to the sixth signal energy;
fourth cross-polarization isolation (I4) corresponding to the fourth reference signal, where the I4 is determined based on a ratio of the seventh signal energy to the eighth signal energy;
a result of comparison between the XPD3 and a third preset value;
a result of comparison between the XPD4 and the third preset value;
a result of comparison between the I3 and a fourth preset value; or
a result of comparison between the I4 and the fourth preset value.

The third reference signal and the fourth reference signal are generated based on a pseudo-random sequence signal pair, and sequence initialization values corresponding to the third reference signal and the fourth reference signal are different from sequence initialization values corresponding to the pseudo-random sequence signal pair.

The transceiver unit 810 is further configured to receive fourth indication information sent by the network device, where the fourth indication information is determined by the network device based on the second parameter, and the fourth indication information indicates whether the transceiver unit 810 sends uplink information by using the polarization multiplexing mechanism.

The transceiver unit 810 is further configured to determine, based on the fourth indication information, whether to send the uplink information by using the polarization multiplexing mechanism.

The third indication information and/or the fourth indication information are/is transmitted in the third polarization direction, or the third indication information and/or the fourth indication information are/is transmitted in the fourth polarization direction.

In some embodiments, the communication apparatus 800 may be configured to implement functions of the network device in the foregoing method 500. For example, the communication apparatus 800 may correspond to the network device.

The communication apparatus 800 may be a network device and perform the steps performed by the network device in the foregoing method 500. The transceiver unit 810 may be configured to support the communication apparatus 800 in performing communication, for example, performing a sending and/or receiving action performed by the network device in the foregoing method 500. The processing unit 820 may be configured to support the communication apparatus 800 in performing a processing action in the foregoing method embodiment, for example, performing a processing action performed by the network device in the foregoing method 500.

Optionally, the communication apparatus may further include a storage unit 830 (not shown in FIG. 8), configured to store program code and data of the communication apparatus.

For details, refer to the following descriptions.

The transceiver unit 810 is configured to send first indication information to a terminal device.

The processing unit 820 is configured to determine the first indication information based on a first parameter.

The first indication information indicates the terminal device to feed back the first parameter, and the first parameter indicates a degree of crosstalk between a first reference signal and a second reference signal.

The first reference signal and the second reference signal are transmitted on a first time domain resource, a first frequency domain resource, and a first space domain resource. The first reference signal is transmitted in a first polarization direction, the second reference signal is transmitted in a second polarization direction, and the first polarization direction and the second polarization direction are two mutually orthogonal polarization directions used for a polarization multiplexing mechanism. The network device sends the first reference signal and the second reference signal to the terminal device.

Optionally, the first polarization direction may be left-hand circular polarization, and the second polarization direction may be right-hand circular polarization.

Optionally, the first polarization direction may be horizontal linear polarization, and the second polarization direction may be vertical linear polarization.

Optionally, the first polarization direction may be positive 45-degree polarization, and the second polarization direction may be negative 45-degree polarization.

The transceiver unit 810 is further configured to receive the first parameter sent by the terminal device.

The transceiver unit 810 is further configured to receive first capability indication information sent by the terminal device, where the first capability indication information indicates that the terminal device supports the polarization multiplexing mechanism.

It should be understood that, that the terminal device supports the polarization multiplexing mechanism may be that the terminal device has a receive antenna for receiving reference signals transmitted in the first polarization direction and the second polarization direction.

The first parameter includes one or more of the following:
first signal energy and second signal energy, where the first signal energy is energy of the first reference signal in the first polarization direction, and the second signal energy is energy of the second reference signal in the first polarization direction;
third signal energy and fourth signal energy, where the third signal energy is energy of the second reference signal in the second polarization direction, and the fourth signal energy is energy of the first reference signal in the second polarization direction;
the first signal energy and the fourth signal energy;
the second signal energy and the third signal energy;
first cross-polarization discrimination (XPD1) corresponding to the first reference signal, where the XPD1 is determined based on a ratio of the first signal energy to the fourth signal energy;
second cross-polarization discrimination (XPD2) corresponding to the second reference signal, where the XPD2 is determined based on a ratio of the third signal energy to the second signal energy;
first cross-polarization isolation (I1) corresponding to the first reference signal, where the I1 is determined based on a ratio of the first signal energy to the second signal energy;
second cross-polarization isolation (I2) corresponding to the second reference signal, where the I2 is determined based on a ratio of the third signal energy to the fourth signal energy;
a result of comparison between the XPD1 and a first preset value;
a result of comparison between the XPD2 and the first preset value;
a result of comparison between the I1 and a second preset value; or
a result of comparison between the I2 and the second preset value.

The first reference signal and the second reference signal are generated based on a pseudo-random sequence signal pair, and sequence initialization values corresponding to the first reference signal and the second reference signal are different from sequence initialization values corresponding to the pseudo-random sequence signal pair.

The transceiver unit 810 is further configured to send second indication information to the terminal device, where the second indication information is determined based on the first parameter, and the second indication information indicates whether the terminal device receives downlink information by using the polarization multiplexing mechanism.

The first indication information and/or the second indication information are/is transmitted in the first polarization direction, or the first indication information and/or the second indication information are/is transmitted in the second polarization direction.

In some embodiments, the communication apparatus 800 may be configured to implement functions of the network device in the foregoing method 600. For example, the communication apparatus 800 may correspond to the network device.

The communication apparatus 800 may be a network device and perform the steps performed by the network device in the foregoing method 600. The transceiver unit 810 may be configured to support the communication apparatus 800 in performing communication, for example, performing a sending and/or receiving action performed by the network device in the foregoing method 600. The processing unit 820 may be configured to support the communication apparatus 800 in performing a processing action in the foregoing method embodiment, for example, performing a processing action performed by the network device in the foregoing method 600.

Optionally, the communication apparatus may further include a storage unit 830 (not shown in FIG. 8), configured to store program code and data of the communication apparatus.

For details, refer to the following descriptions.

The transceiver unit 810 is configured to send third indication information to a terminal device.

The processing unit 820 is configured to determine a second parameter.

The third indication information indicates the terminal device to send a third reference signal and a fourth reference signal to the transceiver unit 810 on a second time domain resource, a second frequency domain resource, and a second space domain resource, the third reference signal and the fourth reference signal are used by the processing unit 820 to determine the second parameter, and the second parameter indicates a degree of crosstalk between the third reference signal and the fourth reference signal.

The third reference signal is transmitted in a third polarization direction, the fourth reference signal is transmitted in a fourth polarization direction, and the third polarization direction and the fourth polarization direction are mutually orthogonal polarization directions used for a polarization multiplexing mechanism.

Optionally, the third polarization direction may be left-hand circular polarization, and the fourth polarization direction may be right-hand circular polarization.

Optionally, the third polarization direction may be horizontal linear polarization, and the fourth polarization direction may be vertical linear polarization.

Optionally, the third polarization direction may be positive 45-degree polarization, and the fourth polarization direction may be negative 45-degree polarization.

That the processing unit 820 is configured to measure the third reference signal and the fourth reference signal includes one or more of the following:

The processing unit 820 measures fifth signal energy and sixth signal energy;
the processing unit 820 measures seventh signal energy and eighth signal energy;
the processing unit 820 measures the fifth signal energy and the eighth signal energy; or
the processing unit 820 measures the sixth signal energy and the seventh signal energy.

The fifth signal energy is energy of the third reference signal in the third polarization direction, the sixth signal energy is energy of the fourth reference signal in the third polarization direction, the seventh signal energy is energy of the fourth reference signal in the fourth polarization direction, and the eighth signal energy is energy of the third reference signal in the fourth polarization direction.

The second parameter includes one or more of the following:
the fifth signal energy and the sixth signal energy;
the seventh signal energy and the eighth signal energy;
the fifth signal energy and the eighth signal energy;
the sixth signal energy and the seventh signal energy;
third cross-polarization discrimination (XPD3) corresponding to the third reference signal, where
the XPD3 is determined based on a ratio of the fifth signal energy to the eighth signal energy;
fourth cross-polarization discrimination (XPD4) corresponding to the fourth reference signal, where
the XPD4 is determined based on a ratio of the seventh signal energy to the sixth signal energy;
third cross-polarization isolation (I3) corresponding to the third reference signal, where the I3 is determined based on a ratio of the fifth signal energy to the sixth signal energy;
fourth cross-polarization isolation (I4) corresponding to the fourth reference signal, where
the I4 is determined based on a ratio of the seventh signal energy to the eighth signal energy;
a result of comparison between the XPD3 and a third preset value;
a result of comparison between the XPD4 and the third preset value;
a result of comparison between the I3 and a fourth preset value; or
a result of comparison between the I4 and the fourth preset value.

The third reference signal and the fourth reference signal are generated based on a pseudo-random sequence signal pair, and sequence initialization values corresponding to the third reference signal and the fourth reference signal are different from sequence initialization values corresponding to the pseudo-random sequence signal pair.

The transceiver unit 810 is further configured to send fourth indication information to the terminal device, where the fourth indication information is determined by the processing unit 820 based on the second parameter, and the fourth indication information indicates whether the terminal device sends uplink information by using the polarization multiplexing mechanism.

The third indication information and/or the fourth indication information are/is transmitted in the third polarization direction, or the third indication information and/or the fourth indication information are/is transmitted in the fourth polarization direction.

FIG. 9 is an example of a signal transmission apparatus 900 according to an embodiment.

As shown in FIG. 9, the apparatus 900 includes a transceiver 910, a processor 920, and a memory 930. The memory 930 is configured to store instructions.

The processor 920 is coupled to the memory 930 and is configured to execute the instructions stored in the memory, to perform the method provided in the foregoing embodiments.

The transceiver 910 in the apparatus 900 may correspond to the transceiver unit 810 in the apparatus 800, and the processor 920 in the communication apparatus 900 may correspond to the processing unit 820 in the communication apparatus 800.

It should be understood that the memory 930 and the processor 920 may be integrated into one processing apparatus. The processor 920 is configured to execute program code stored in the memory 930, to implement the foregoing functions. During specific implementation, the memory 930 may alternatively be integrated into the processor 920 or may be independent of the processor 920.

A person of ordinary skill in the art understand that, in combination with the examples described in the embodiments, units and algorithm steps may be implemented by electronic hardware or a combination of computer software and electronic hardware. Whether the functions are performed by hardware or software depends on particular applications and design constraints of the solutions. A skilled person may use different methods to implement the described functions for each specific application, but it should not be considered that the implementation goes beyond the scope of the embodiments.

It may be clearly understood by a person skilled in the art that, for the purpose of convenient and brief description, for a detailed working process of the foregoing system, apparatus, and unit, refer to a corresponding process in the foregoing method embodiments. Details are not described herein again.

In the several embodiments provided, it should be understood that the systems, apparatuses, and methods may be implemented in other manners. For example, the described apparatus embodiments are merely examples. For example, division into the units is merely logical function division, and there may be another division manner during actual implementation. For example, a plurality of units or components may be combined or integrated into another system, or some features may be ignored or may not be performed. In addition, the displayed or discussed mutual couplings or direct couplings or communication connections may be implemented through some interfaces. The indirect couplings or communication connections between apparatuses or units may be implemented in electrical, mechanical, or other forms.

The units described as separate parts may or may not be physically separate, and parts displayed as units may or may not be physical units, that is, may be located at one position, or may be distributed on a plurality of network units. Some or all of the units may be selected based on actual requirements to achieve the objectives of the solutions of embodiments.

In addition, functional units in embodiments may be integrated into one processing unit, each of the units may exist alone physically, or two or more units may be integrated into one unit.

When the functions are implemented in a form of a software functional unit and sold or used as an independent product, the functions may be stored in a non-transitory computer-readable storage medium. Based on such an understanding, the solutions in this embodiments essentially, or the part contributing to the conventional technology, or some of the solutions may be implemented in a form of a software product. The computer software product is stored in a storage medium, and includes several instructions for instructing a computer device (which may be a personal computer, a server, a network device, or the like) to perform all or some of the steps of the methods described in the embodiments. The foregoing storage medium includes any medium that can store program code, such as a USB flash drive, a removable hard disk, a read-only memory (ROM), a random access memory (RAM), a magnetic disk, or an optical disc.

The foregoing descriptions are merely implementations of the embodiments, but the scope of the embodiments is not limited thereto. Any variation or replacement readily figured out by a person skilled in the art shall fall within the scope of the embodiments.

What is claimed is:

1. A method, comprising:
receiving, by a first communication apparatus, first indication information sent by a network device, wherein the first indication information indicates the first communication apparatus to feed back a first parameter, the first parameter indicates a degree of crosstalk between a first reference signal and a second reference signal, the first reference signal and the second reference signal are transmitted on a first time domain resource, a first frequency domain resource, and a first space domain resource, the first reference signal is transmitted in a first polarization direction, the second reference signal is transmitted in a second polarization direction, and the first polarization direction and the second polarization direction are two mutually orthogonal polarization directions used for a polarization multiplexing mechanism;
measuring, by the first communication apparatus, the first reference signal and the second reference signal based on the first indication information, to obtain the first parameter; and
sending, by the first communication apparatus, the first parameter to the network device.

2. The method according to claim 1, wherein before receiving, by the first communication apparatus, the first indication information sent by the network device, the method further comprises:
sending, by the first communication apparatus, first capability indication information to the network device, wherein the first capability indication information indicates that the first communication apparatus supports the polarization multiplexing mechanism.

3. The method according to claim 1, wherein measuring, by the first communication apparatus, of the first reference signal and the second reference signal based on the first indication information comprises at least one of:
measuring, by the first communication apparatus, first signal energy and second signal energy;
measuring, by the first communication apparatus, third signal energy and fourth signal energy;
measuring, by the first communication apparatus, the first signal energy and the fourth signal energy; or
measuring, by the first communication apparatus, the second signal energy and the third signal energy, wherein
the first signal energy is energy of the first reference signal in the first polarization direction, the second signal energy is energy of the second reference signal in the first polarization direction, the third signal energy is energy of the second reference signal in the second polarization direction, and the fourth signal energy is energy of the first reference signal in the second polarization direction.

4. The method according to claim 3, wherein the first parameter comprises at least one of:
the first signal energy and the second signal energy;
the third signal energy and the fourth signal energy;
the first signal energy and the fourth signal energy;
the second signal energy and the third signal energy;
first cross-polarization discrimination (first XPD) corresponding to the first reference signal, wherein the first XPD is determined based on a ratio of the first signal energy to the fourth signal energy;
second cross-polarization discrimination (second XPD) corresponding to the second reference signal, wherein the second XPD is determined based on a ratio of the third signal energy to the second signal energy;
first cross-polarization isolation (first I) corresponding to the first reference signal, wherein the first I is determined based on a ratio of the first signal energy to the second signal energy;
second cross-polarization isolation (second I) corresponding to the second reference signal, wherein the second I is determined based on a ratio of the third signal energy to the fourth signal energy;
a result of comparison between the first XPD and a first preset value;
a result of comparison between the second XPD and the first preset value;
a result of comparison between the first I and a second preset value; or
a result of comparison between the second I and the second preset value.

5. The method according to claim 1, wherein the first reference signal and the second reference signal are generated based on a pseudo-random sequence signal pair, and sequence initialization values corresponding to the first reference signal and the second reference signal are different from sequence initialization values corresponding to the pseudo-random sequence signal pair.

6. The method according to claim 1, further comprising:
receiving, by the first communication apparatus, second indication information sent by the network device, wherein the second indication information is determined based on the first parameter, and the second indication information indicates whether the first communication apparatus receives downlink information by using the polarization multiplexing mechanism; and
determining, by the first communication apparatus based on the second indication information, whether to receive the downlink information by using the polarization multiplexing mechanism.

7. The method according to claim 6, wherein at least one of the following information is transmitted in the first polarization direction or the second polarization direction:
the first indication information; or
the second indication information.

8. A method, comprising:
receiving, by a first communication apparatus, third indication information sent by a network device, wherein the third indication information indicates the first communication apparatus to send a third reference signal and a fourth reference signal to the network device on a second time domain resource, a second frequency domain resource, and a second space domain resource, the third reference signal and the fourth reference signal are used by the network device to determine a second parameter, the second parameter indicates a degree of crosstalk between the third reference signal and the fourth reference signal, the third reference signal is transmitted in a third polarization direction, the fourth reference signal is transmitted in a fourth polarization direction, and the third polarization direction and the fourth polarization direction are two mutually orthogonal polarization directions used for a polarization multiplexing mechanism; and
sending, by the first communication apparatus, the third reference signal and the fourth reference signal to the network device based on the third indication information.

9. The method according to claim 8, wherein before receiving, by the first communication apparatus, the third indication information sent by the network device, the method further comprises:
sending, by the first communication apparatus, second capability indication information to the network device, wherein the second capability indication information indicates that the first communication apparatus supports the polarization multiplexing mechanism.

10. The method according to claim 8, wherein the second parameter comprises at least one of:
fifth signal energy and sixth signal energy, wherein the fifth signal energy is energy of the third reference signal in the third polarization direction, and the sixth signal energy is energy of the fourth reference signal in the third polarization direction;
seventh signal energy and eighth signal energy, wherein the seventh signal energy is energy of the fourth reference signal in the fourth polarization direction, and the eighth signal energy is energy of the third reference signal in the fourth polarization direction;
the fifth signal energy and the eighth signal energy;
the sixth signal energy and the seventh signal energy;
third cross-polarization discrimination (third XPD) corresponding to the third reference signal, wherein the third XPD is determined based on a ratio of the fifth signal energy to the eighth signal energy;
fourth cross-polarization discrimination (fourth XPD) corresponding to the fourth reference signal, wherein the fourth XPD is determined based on a ratio of the seventh signal energy to the sixth signal energy;
third cross-polarization isolation (third I) corresponding to the third reference signal, wherein the third I is determined based on a ratio of the fifth signal energy to the sixth signal energy;
fourth cross-polarization isolation (fourth I) corresponding to the fourth reference signal, wherein the fourth I is determined based on a ratio of the seventh signal energy to the eighth signal energy;
a result of comparison between the third XPD and a third preset value;
a result of comparison between the fourth XPD and the third preset value;
a result of comparison between the third I and a fourth preset value; or
a result of comparison between the fourth I and the fourth preset value.

11. The method according to claim 8, wherein the third reference signal and the fourth reference signal are generated based on a pseudo-random sequence signal pair, and sequence initialization values corresponding to the third reference signal and the fourth reference signal are different from sequence initialization values corresponding to the pseudo-random sequence signal pair.

12. The method according to claim 8, further comprising:
receiving, by the first communication apparatus, fourth indication information sent by the network device, wherein the fourth indication information is determined by the network device based on the second parameter, and the fourth indication information indicates whether the first communication apparatus sends uplink information by using the polarization multiplexing mechanism; and
determining, by the first communication apparatus based on the fourth indication information, whether to send the uplink information by using the polarization multiplexing mechanism.

13. The method according to claim 12, wherein at least one of the following information is transmitted in the third polarization direction or the fourth polarization direction:
the third indication information; or
the fourth indication information.

14. A method, comprising:
sending, by a second communication apparatus, first indication information to a terminal device, wherein the first indication information indicates the terminal device to feed back a first parameter, the first parameter indicates a degree of crosstalk between a first reference signal and a second reference signal, the first reference signal and the second reference signal are transmitted on a first time domain resource, a first frequency domain resource, and a first space domain resource, the first reference signal is transmitted in a first polarization direction, the second reference signal is transmitted in a second polarization direction, and the first polarization direction and the second polarization direction are two mutually orthogonal polarization directions used for a polarization multiplexing mechanism;
sending, by the second communication apparatus, the first reference signal and the second reference signal to the terminal device; and
receiving, by the second communication apparatus, the first parameter sent by the terminal device.

15. The method according to claim 14, wherein before sending, by the second communication apparatus, the first indication information to the terminal device, the method further comprises:
receiving, by the second communication apparatus, first capability indication information sent by the terminal device, wherein the first capability indication information indicates that the terminal device supports the polarization multiplexing mechanism.

16. The method according to claim 14, wherein the first parameter comprises at least one of:
first signal energy and second signal energy, wherein the first signal energy is energy of the first reference signal in the first polarization direction, and the second signal energy is energy of the second reference signal in the first polarization direction;
third signal energy and fourth signal energy, wherein the third signal energy is energy of the second reference signal in the second polarization direction, and the fourth signal energy is energy of the first reference signal in the second polarization direction;
the first signal energy and the fourth signal energy;
the second signal energy and the third signal energy;
first cross-polarization discrimination (first XPD) corresponding to the first reference signal, wherein the first XPD is determined based on a ratio of the first signal energy to the fourth signal energy;
second cross-polarization discrimination (second XPD) corresponding to the second reference signal, wherein the second XPD is determined based on a ratio of the third signal energy to the second signal energy;
first cross-polarization isolation (first I) corresponding to the first reference signal, wherein the first I is determined based on a ratio of the first signal energy to the second signal energy;
second cross-polarization isolation (second I) corresponding to the second reference signal, wherein the second I is determined based on a ratio of the third signal energy to the fourth signal energy;
a result of comparison between the first XPD and a first preset value;
a result of comparison between the second XPD and the first preset value;
a result of comparison between the first I and a second preset value; or
a result of comparison between the second I and the second preset value.

17. The method according to claim 14, wherein the first reference signal and the second reference signal are generated based on a pseudo-random sequence signal pair, and sequence initialization values corresponding to the first reference signal and the second reference signal are different from sequence initialization values corresponding to the pseudo-random sequence signal pair.

18. The method according to claim 14, further comprising:
sending, by the second communication apparatus, second indication information to the terminal device, wherein the second indication information is determined based on the first parameter, and the second indication information indicates whether the terminal device receives downlink information by using the polarization multiplexing mechanism.

19. The method according to claim 18, wherein at least one of the following information is transmitted in the first polarization direction or the second polarization direction:
the first indication information; or
the second indication information.

20. A method, comprising:
sending, by a second communication apparatus, third indication information to a terminal device, wherein the third indication information indicates the terminal device to send a third reference signal and a fourth reference signal to the second communication apparatus on a second time domain resource, a second frequency domain resource, and a second space domain resource, the third reference signal and the fourth reference signal are used by the second communication apparatus to determine a second parameter, the second parameter indicates a degree of crosstalk between the third reference signal and the fourth reference signal, the third reference signal is transmitted in a third polarization direction, the fourth reference signal is transmitted in a fourth polarization direction, and the third polarization direction and the fourth polarization direction are mutually orthogonal polarization directions used for a polarization multiplexing mechanism; and
measuring, by the second communication apparatus, the third reference signal and the fourth reference signal, to determine the second parameter.
